(19) United States
(12) Patent Application Publication
(10) Pub. No.: US 2009/0112828 A1
(43) Pub. Date: Apr. 30, 2009

(54) METHOD AND SYSTEM FOR ANSWER EXTRACTION

(75) Inventor: Assaf Rozenblatt, Brooklyn, NY (US)

Correspondence Address: DARBY & DARBY P.C., P.O. BOX 770, Church Street Station, New York, NY, 10008-0770, US

(73) Assignee: ANSWERS CORPORATION, NEW YORK, NY (US)

(21) Appl. No.: 10/595,252

(22) PCT Filed: Mar. 13, 2006
(86) PCT No.: PCT/US06/09131

§ 371 Date: Mar. 30, 2006

(51) Int. Cl. G06F 17/30

(52) U.S. Cl. 707/4; 707/E17.014

(57) ABSTRACT

A document searching method including employing a computer to receive, from a user, a query including at least one search term, employing computerized answer retrieving functionality to generate document search terms including at least one additional search term not present in the query, which the at least one additional search term was acquired, prior to receipt by the computer of the query from the user, by the computerized answer retrieving functionality in response to at least one query in the form of a question; and operating computerized search engine functionality to access a set of documents in response to the query, based not only on at least one search term supplied by the user in the query, but also on the at least one additional search term provided by the computerized answer retrieving functionality.

### FIELD OF THE INVENTION

The present invention relates to document searching methodologies and systems generally.

### BACKGROUND OF THE INVENTION

The following patent publications are believed to represent the current state of the art:

U.S. Pat. Nos. 6,910,003; 6,584,470; 6,601,026; 6,560,590; 6,665,640; 6,615,172; 5,574,908; 6,901,399; 6,766,316; 6,758,397; 6,745,161; 6,676,014; 6,633,846; 6,616,047 and 6,491,217;

U.S. Patent Application Publication Nos. 2004/0243417; 2004/0111408; 2004/0083092; 2003/0182391 and 2002/0002452.

### SUMMARY OF THF INVENTION

The present invention seeks to provide improved document searching methodologies and systems.

There is thus provided in accordance with a preferred embodiment of the present invention a document searching method including employing a computer to receive, from a user, a query including at least one search term, employing computerized answer retrieving functionality to generate document search terms including at least one additional search term not present in the query, which the at least one additional search term was acquired, prior to receipt by the computer of the query from the user, by the computerized answer retrieving functionality in response to at least one query in the form of a question; and operating computerized search engine functionality to access a set of documents in response to the query, based not only on at least one search term supplied by the user in the query, but also on the at least one additional search term provided by the computerized answer retrieving functionality.

There is also provided in accordance with another preferred embodiment of the present invention a system for document searching including a computer operative to receive, from a user, a query including at least one search term, computerized answer retrieving functionality operative to generate document search terms including at least one additional search term not present in the query, which the at least one additional search term was acquired, prior to receipt by the computer of the query from the user, by the computerized answer retrieving functionality in response to at least one query in the form of a question and computerized search engine functionality operative to access a set of documents in response to the query, based not only on the at least one search term but also on the at least one additional search term provided by the computerized answer retrieving functionality.

Preferably, the query is a question. Alternatively, the query is not a question.

Preferably, the employing computerized answer retrieving functionality provides the at least one additional search term by retrieving search terms, acquired other than in response to earlier questions, received by the computerized answer retrieving functionality prior to receipt of the query from the user.

There is further provided in accordance with yet another preferred embodiment of the present invention an answer extraction method including employing a computer to receive a question from a user, employing a computer network to access a set of documents relevant to the question by employing document search terms derived by the computer from the question, the document search terms including at least one additional search term not present in the question, which the at least one additional search term was acquired prior to receipt of the question from the user, analyzing the set of documents to extract at least one answer to the question; and providing the at least one answer to the user.

Preferably, the employing a computer network includes providing the at least one additional search term, by retrieving search terms acquired in response to earlier questions, received prior to receipt of the question from the user. Alternatively, the employing a computer network includes providing the at least one additional search term by retrieving search terms, acquired other than in response to earlier questions, received prior to receipt of the question from the user.

In a preferred embodiment of the present invention the employing a computer includes employing the computer to receive the query or question by at least one of typing the query or question, using a voice responsive input device, using a screen scraping functionality, using an email functionality, using an SMS functionality and using an instant messaging functionality.

Preferably, the employing computerized answer retrieving functionality to generate document search terms includes utilizing computerized query normalizing functionality for normalizing the query. Additionally, the normalizing the query is performed based at least in part on at least one of a plurality of query normalization rules.

Preferably, the employing computerized answer retrieving functionality to generate document search terms or the employing document search terms includes generating document search terms, including the at least one additional search term not present in the query or question by replacing at least one word in the query or question by at least one selected synonym thereof. Additionally, the replacing at least one word in the query or question by at least one selected synonym thereof includes employing computerized synonym retrieving functionality to identify the at least one selected synonym at least partially by reference to at least one word in the query or question other than the at least one word which is replaced by the at least one selected synonym. Additionally, the employing computerized synonym retrieving functionality includes identifying the at least one selected synonym by identifying a plurality of synonyms and selecting at least one of the plurality of synonyms for which there exists a phrase in a corpus which is relevant to the query or question. Additionally, the identifying the at least one selected synonym includes searching the corpus for occurrences of at least one of the plurality of synonyms for which there exists a phrase in the corpus which is relevant to the query or question and designating at least one of the plurality of synonyms as a selected synonym in accordance with a number of occurrences in the corpus of a phrase including the at least one of the plurality of synonyms which is relevant to the query or question.

Preferably, the document searching method also includes utilizing computerized query processing functionality to process the query prior to the operating computerized search engine functionality, the utilizing computerized query processing functionality including utilizing the computerized query processing functionality to generate at least one expected answer to the query, utilizing the computerized query processing functionality to generate at least one preliminary search engine query based on the at least one expected answer, utilizing the computerized query processing functionality to concatenate the at least one preliminary search engine query with the at least one additional search term not present in the query, thereby to form a concatenated search engine query and providing the concatenated search engine query to the computerized search engine functionality.

In accordance with another preferred embodiment the document searching method or the answer extraction method also includes providing a representation of at least one document in the set of documents to the user. Additionally, the providing a representation includes presenting at least one link to the at least one document.

Preferably, the document searching method also includes extracting at least one answer to the query from at least one document in the set of documents and providing the at least one answer to the user. Additionally, the extracting at least one answer includes analyzing the at least one document by carrying out theme extraction on the at least one document, the theme extraction utilizing statistical analysis of frequency of occurrence of words to identify at least one theme word of the at least one document, extracting sentences from the at least one document, selecting at least one of the sentences as a potential answer, scoring each of the at least one of the sentences selected as a potential answer and identifying the at least one of the sentences selected as a potential answer based at least partially on results of the scoring.

Preferably, the analyzing the set of documents to extract at least one answer to the question includes carrying out theme extraction on plural ones of the set of documents, the theme extraction utilizing statistical analysis of frequency of occurrence of words to identify at least one theme word of the at least one document, extracting sentences from the at least one document, selecting at least one of the sentences as a potential answer, scoring each of the at least one of the sentences and identifying at least one of the sentences selected as a potential answer based at least partially on results of the scoring.

Alternatively or additionally, the extracting at least one answer or the analyzing the set of documents to extract the at least one answer includes enhancing the at least one document by identifying capitalized phrases which appear in the at least one document, identifying designated capitalized words belonging to the capitalized phrases and adding, to the at least one document, adjacent each occurrence of a designated capitalized word that does not appear in a capitalized phrase, the designated capitalized word that does appear alongside thereof elsewhere in the document in a capitalized phrase and carrying out analysis of the at least one document in order to identify at least one portion thereof as a potential answer. Additionally or alternatively, the providing the at least one answer to the user includes presenting the at least one answer in an editable report precursor format.

Preferably, the employing computerized answer retrieving functionality includes employing artificial intelligence.

Preferably, the computerized answer retrieving functionality is operative to provide the at least one additional search term, by retrieving search terms acquired other than in response to earlier questions, received by the computerized answer retrieving functionality prior to receipt of the query from the user.

In a preferred embodiment of the present invention the computer is operative to receive the query or question from at least one of a keyboard, a voice responsive input device, a screen scraping functionality, an email functionality, an SMS functionality and an instant messaging functionality.

Preferably, the computerized answer retrieving functionality includes computerized query normalizing functionality for normalizing the query. Additionally, the computerized query normalizing functionality is operative to normalize the query based at least in part on at least one of a plurality of query normalization rules.

Preferably, the computerized answer retrieving functionality or the computerized answer extraction functionality is operative to generate the at least one additional search term not present in the query or question by replacing at least one word in the query or question by at least one selected synonym thereof. Additionally, the computerized answer retrieving functionality or the computerized answer extraction functionality includes computerized synonym retrieving functionality operative to identify the at least one selected synonym at least partially by reference to at least one word in the query or question other than the at least one word which is replaced by the at least one selected synonym. Additionally, the computerized synonym retrieving functionality includes a corpus and the computerized synonym retrieving functionality is operative to search the corpus for occurrences of at least one of a plurality of synonyms for which there exists a phrase relevant to the query or question and to designate at least one of the plurality of synonyms as a selected synonym in accordance with a number of occurrences in the corpus of a phrase including the at least one synonym which is relevant to the query or question.

Preferably, the system for document searching or the answer extraction system also includes a document output device for providing a representation of at least one document in the set of documents to the user. Additionally, the document output device includes a display for presenting at least one link to the at least one document.

In accordance with another preferred embodiment the system for document searching also includes computerized answer extraction functionality for extracting at least one answer from at least one document in the set of documents and an answer output device for providing the at least one answer to the user. Additionally, the computerized answer extraction functionality includes a document analyzer operative to analyze the at least one document, the document analyzer including computerized theme extraction functionality for carrying out theme extraction on the at least one document, the theme extraction utilizing statistical analysis of frequency of occurrence of words to identify at least one theme word of the at least one document, computerized sentence extracting functionality for extracting sentences from the at least one document, a potential answer selector for selecting at least one of the sentences as a potential answer, computerized scoring functionality for scoring each of the at least one of the sentences and a sentence identifier for identifying at least one of the sentences selected as a potential answer based at least partially on results of the scoring. Alternatively or additionally, the answer output device includes a display for presenting the at least one answer to the user in an editable report precursor format.

Preferably, the computerized answer retrieving functionality includes artificial intelligence.

Preferably, the employing a computer network employs artificial intelligence.

Preferably, the employing document search terms includes utilizing computerized question normalizing functionality for normalizing the question. Additionally, the normalizing the question is performed based at least in part on at least one of a plurality of question normalization rules.

Preferably, the answer extraction method also includes utilizing computerized question processing functionality to process the question, the utilizing computerized question processing functionality including utilizing the computerized question processing functionality to generate at least one expected answer to the question, utilizing the computerized question processing functionality to generate at least one preliminary search engine query based on the at least one expected answer, utilizing the computerized question processing functionality to concatenate the at least one preliminary search engine query with the at least one additional search term not present in the question, thereby to form a concatenated search engine query and deriving the document search terms from the concatenated search engine query.

Preferably, the providing the at least one answer to the user also includes providing a representation of at least one document of the set of documents to the user. Additionally, the providing a representation includes presenting at least one link to the at least one document.

In another preferred embodiment of the present invention the question is not phrased in question format.

There is even further provided in accordance with still another preferred embodiment of the present invention an answer extraction system including a computer operative to receive a question from a user, computerized answer extraction functionality operative to employ a computer network to access a set of documents relevant to the question by employing document search terms derived by the computer from the question, the document search terms including at least one additional search term not present in the question, which the at least one additional search term was acquired prior to receipt of the question from the user, computerized answer analysis functionality for analyzing the set of documents to extract at least one answer to the question and an output device operative to provide the at least one answer to the user.

Preferably, the computer network provides the at least one additional search term by retrieving search terms, acquired in response to earlier questions, received prior to receipt of the question from the user. Alternatively, the computer network provides the at least one additional search term by retrieving search terms, acquired other than in response to earlier questions, received prior to receipt of the question from the user. Additionally or alternatively, the computer network employs artificial intelligence.

Preferably, the computerized answer extraction functionality includes computerized question normalizing functionality for normalizing the question. Additionally, the computerized question normalizing functionality is operative to normalize the question based at least in part on at least one of a plurality of question normalization rules.

Preferably, the output device is operative to provide a representation of at least one document of the set of documents to the user. Additionally, the output device includes a display for presenting at least one link to the at least one document to the user.

Preferably, the computerized answer extraction functionality includes computerized theme extraction functionality for carrying out theme extraction on plural ones of the set of documents, the theme extraction utilizing statistical analysis of frequency of occurrence of words to identify at least one theme word of the at least one document, computerized sentence extracting functionality for extracting sentences from the at least one document, a potential answer selector for selecting at least one of the sentences as a potential answer, scoring functionality for scoring each the at least one of the sentences and a sentence identifier for identifying at least one of the sentences selected as a potential answer based at least partially on results of the scoring.

There is also provided in accordance with another preferred embodiment of the present invention an answer extraction method including employing a computer to receive a question from a user, employing a computer network to access a set of documents relevant to the question by employing document search terms derived by the computer from the question, extracting at least one answer to the question and providing the at least one answer to the user, the extracting at least one answer including generating an expected answer to the question, the expected answer including question keywords, analyzing the set of documents by carrying out theme extraction on plural ones of the set of documents, the theme extraction utilizing statistical analysis of the frequency of occurrence of words to identify at least one theme word of a document, which theme word may or may not be a question keyword and extracting sentences from plural ones of the set of documents, selecting at least one of the sentences as a potential answer if it fulfills at least one of the following criteria: a sentence including at least a predetermined plurality of question keywords and a sentence including at least one question keyword and at least one theme word, scoring each of the at least one of the sentences selected as a potential answer and identifying at least one of the at least one of the sentences selected as a potential answer based at least partially on results of the scoring.

Preferably, the answer extraction method also includes, prior to the employing a computer network to access a set of documents, utilizing computerized question normalization functionality for normalizing the question and thereafter, utilizing computerized question classification functionality to classify the question.

Preferably, the employing a computer network includes employing the computer to derive the document search terms, including at least one additional search term not present in the question, which the at least one additional search term was acquired prior to receipt of the question from the user. Alternatively, the employing a computer network includes employing the computer to derive the document search terms, including at least one additional search term not present in the question, by replacing at least one word in the question by at least one selected synonym thereof.

Preferably, the statistical analysis includes for each word in the document, stemming the word to a corresponding root word, generating a word occurrence frequency score for each different root word corresponding to a word in the document, using the word occurrence frequency scores to calculate a document word occurrence frequency indicating score for the document, selecting a subset of words in the document including at least one word having a word occurrence frequency score which is greater than or equal to the document word occurrence frequency indicating score. Additionally, the document word occurrence frequency indicating score includes at least one of an average of the word occurrence frequency scores and a median of the word occurrence frequency scores. Additionally or alternatively, the statistical analysis, the extracting a theme or the identifying at least one theme word includes selecting, as the at least one theme word, at least one word having a word occurrence frequency score which is greater than or equal to twice the document word occurrence frequency indicating score.

Preferably, the statistical analysis also includes following the selecting a subset of words in the document or the potential answer document, calculating a subset word occurrence frequency indicating score and selecting, as the at least one theme word, at least one of the subset of words having a word occurrence frequency score which is greater than or equal to the subset word occurrence frequency indicating score. Additionally, the subset word occurrence frequency indicating score includes at least one of an average of the word occurrence frequency scores of words in the subset of words and a median of the word occurrence frequency scores of words in the subset of words.

There is further provided in accordance with still another preferred embodiment of the present invention an answer extraction system including a computer operative to receive a question from a user and computerized answer extraction functionality operative to employ a computer network to access a set of documents relevant to the question by employing document search terms derived by the computer from the question, to extract at least one answer to the question and to provide the at least one answer to the user, the computerized answer extraction functionality including an expected answer generator operative to generate an expected answer to the question, the expected answer including question keywords, a document analyzer operative to carry out theme extraction on plural ones of the set of documents, the theme extraction utilizing statistical analysis of the frequency of occurrence of words in a document to identify at least one theme word of the document, which theme word may or may not be a question keyword, a sentence extractor, operative to extract sentences from plural ones of the set of documents, a potential answer selector, operative to select at least one of the sentences as a potential answer if it fulfills at least one of the following criteria: a sentence including at least a predetermined plurality of question keywords and a sentence including at least one question keyword and at least one theme word and a potential answer identifier, operative to calculate a score for each of the at least one of the sentences selected as a potential answer and to identify at least one of the sentences selected as a potential answer based at least partially on the score.

Preferably, the answer extraction system also includes computerized question normalizing functionality operative to normalize the question and computerized question classification functionality for classifying the question.

Preferably, the computerized answer extraction functionality is operative to employ the computer to derive the document search terms, including at least one additional search term not present in the question, which the at least one additional search term was acquired prior to receipt of the question from the user. Alternatively, the computerized answer extraction functionality is operative to employ the computer to derive the document search terms, including at least one additional search term not present in the question, by replacing at least one word in the question by at least one selected synonym thereof.

Preferably, the answer extraction system also includes an answer output device for providing the at least one answer to the user.

Preferably, the document analyzer or the computerized theme word identifying functionality includes computerized word stemming functionality, operative, for each word in the document, to stem the word to a corresponding root word, a word occurrence frequency score generator for generating a word occurrence frequency score for each different root word corresponding to a word in the document, computerized document word occurrence frequency indicating score calculating functionality operative to use the word occurrence frequency scores to calculate a document word occurrence frequency indicating score for the document and computerized word selecting functionality operative to select a subset of words in the document including at least one word having a word occurrence frequency score which is greater than or equal to the document word occurrence frequency indicating score. Additionally, the computerized document word occurrence frequency indicating score calculating functionality is operative to calculate the document word occurrence frequency indicating score by calculating at least one of an average of the word occurrence frequency scores and a median of the word occurrence frequency scores.

Additionally or alternatively, the computerized word selecting functionality, the computerized theme extraction functionality or the computerized theme word identifying functionality is operative to select, as the at least one theme word, at least one word having a word occurrence frequency score which is greater than or equal to twice the document word occurrence frequency indicating score.

Preferably, the document analyzer, the answer extraction system or the computerized question generation system also includes computerized subset word occurrence frequency indicating score calculating functionality, operative to calculate a subset word occurrence frequency indicating score and computerized theme word selection functionality operative to select, as the at least one theme word, at least one of the subset of words having a word occurrence frequency score which is greater than or equal to the subset word occurrence frequency indicating score. Additionally, the computerized subset word occurrence frequency indicating score calculating functionality is operative to calculate the subset word occurrence frequency indicating score by calculating at least one of an average of the word occurrence frequency scores of words in the subset of words and a median of the word occurrence frequency scores of words in the subset of words.

There is yet further provided in accordance with yet another preferred embodiment of the present invention an answer extraction method including employing a computer to receive a question from a user, employing a computer network to access a set of documents relevant to the question by employing document search terms derived by the computer from the question, extracting at least one answer to the question and providing the at least one answer to the user, the extracting at least one answer including enhancing at least one of the set of documents by identifying capitalized phrases which appear in the at least one document, identifying designated capitalized words belonging to the capitalized phrases and adding, to the at least one document adjacent each occurrence of a designated capitalized word that does not appear in a capitalized phrase, the designated capitalized word that does appear alongside thereof elsewhere in the document in a capitalized phrase and carrying out analysis of the at least one document in order to identify at least one portion thereof as a potential answer.

Preferably, the extracting at least one answer also includes, prior to the enhancing, generating an expected answer to the question, the expected answer including question keywords, and wherein the carrying out analysis of the at least one document includes carrying out theme extraction on the at least one document, the theme extraction utilizing statistical analysis of the frequency of occurrence of words to identify at least one theme word of the at least one document, which theme word may or may not be a question keyword, extracting sentences from the at least one document, selecting at least one of the sentences as a potential answer if it fulfills at least one of the following criteria: a sentence including at least a predetermined plurality of question keywords and a sentence including at least one question keyword and at least one theme word, scoring each of the at least one of the sentences selected as a potential answer and identifying at least one of the sentences selected as a potential answer based at least partially on results of the scoring.

Preferably, the statistical analysis includes for each word in the at least one document, stemming the word to a corresponding root word, generating a word occurrence frequency score for each different root word corresponding to a word in the at least one document, using the word occurrence frequency scores to calculate a document word occurrence frequency indicating score for the at least one document and selecting as potential theme words a subset of words in the at least one document including at least one word having a word occurrence frequency score which is greater than or equal to the document word occurrence frequency indicating score.

Preferably, the selecting as potential theme words includes selecting, as the at least one theme word, at least one word having a word occurrence frequency score which greater than or equal to twice the document word occurrence frequency indicating score. Additionally, the statistical analysis also includes, following the selecting as potential theme words a subset of words in the at least one document, calculating a subset word occurrence frequency indicating score and selecting, as the at least one theme word, at least one of the subset of words having a word occurrence frequency score which is greater than or equal to the subset word occurrence frequency indicating score.

There is even further provided in accordance with another preferred embodiment of the present invention an answer extraction system including a computer operative to receive a question from a user, computerized answer extraction functionality operative to employ a computer network to access a set of documents relevant to the question by employing document search terms derived by the computer from the question, to extract at least one answer to the question and to provide the at least one answer to the user, the computerized answer extraction functionality including a document analyzer operative to identify capitalized phrases which appear in a document belonging to the set of documents, to identify designated capitalized words belonging to the capitalized phrases, to add to the document adjacent each occurrence of a designated capitalized word that does not appear in a capitalized phrase, the designated capitalized word that does appear alongside thereof elsewhere in the document in a capitalized phrase, thereby providing an enhanced document, and to carry out analysis of the enhanced document in order to identify at least one portion thereof as a potential answer.

Preferably, the computerized answer extraction functionality also includes an expected answer generator operative to generate an expected answer to the question, the expected answer including question keywords, and wherein the document analyzer or the computerized document analysis functionality includes computerized theme extraction functionality for carrying out theme extraction on the document or the enhanced document, the theme extraction utilizing statistical analysis of the frequency of occurrence of words to identify at least one theme word of the document or enhanced document, which theme word may or may not be a question keyword, a sentence extractor, operative to extract sentences from the document or enhanced document, a potential answer selector, operative to select at least one of the sentences as a potential answer if it fulfills at least one of the following criteria: a sentence including at least a predetermined plurality of question keywords and a sentence including at least one question keyword and at least one theme word and a potential answer identifier, operative to calculate a score for each of the at least one of the sentences and to identify at least one of the sentences selected as a potential answer based at least partially on results of the score.

There is yet further provided in accordance with another preferred embodiment of the present invention an answer extraction method including employing a computer to receive a question from a user, employing a computer network to access a set of documents relevant to the question by employing document search terms derived by the computer from the question, extracting at least one answer to the question and providing the at least one answer to the user, the extracting at least one answer to the question including identifying a multiplicity of potential answers and evaluating each of the multiplicity of potential answers according to at least one of the following criteria: proximity of question keywords in the potential answer, proximity of classification words and nouns in the potential answer and word count of at least part of the potential answer.

Alternatively, the evaluating includes evaluating each of the multiplicity of potential answers according to at least two of the following criteria, all of the following criteria or a combination of the following criteria: proximity of question keywords in the potential answer, proximity of classification words and nouns in the potential answer and word count of at least part of the potential answer.

Additionally or alternatively, the extracting at least one answer also includes selecting a sub group of the multiplicity of potential answers based on an evaluation of the multiplicity of potential answers in accordance with the criteria. Additionally, the evaluation includes scoring the multiplicity of potential answers in accordance with the criteria.

Preferably, the answer extraction method also includes forming a potential answer document by combining the multiplicity of potential answers, extracting a theme of the sub group of the multiplicity of potential answers, by utilizing statistical analysis of the frequency of occurrence of words in the potential answer document to identify at least one theme word in the sub group of the multiplicity of potential answers, which theme word may or may not be a question keyword and discarding potential answers belonging to the sub group of the multiplicity of potential answers which do not include at least one of the at least one theme word.

Preferably, the statistical analysis includes for each word in the potential answer document, stemming the word to a corresponding root word, generating a word occurrence frequency score for each different root word corresponding to a word in the potential answer document, using the word occurrence frequency scores to calculate a document word occurrence frequency indicating score for the potential answer document and selecting a subset of words in the potential answer document including at least one word having a word occurrence frequency score which is greater than or equal to the document word occurrence frequency indicating score.

Preferably, the providing the at least one answer to the user includes providing the at least one answer to the user in an order governed at least in part by at least one of a word count of each of the at least one answer, a score resulting from application to each of the at least one answer of at least one of the following criteria: proximity of question keywords in the at least one answer, proximity of classification words and nouns in the at least one answer and word count of at least part of the at least one answer.

Preferably, the identifying a multiplicity of potential answers also includes enhancing at least one of the set of documents by identifying capitalized phrases which appear in the at least one of the set of documents, identifying designated capitalized words belonging to the capitalized phrases and adding, to the at least one of the set of documents adjacent each occurrence of a designated capitalized word that does not appear in a capitalized phrase, the designated capitalized word that does appear alongside thereof elsewhere in the document in a capitalized phrase and carrying out analysis of the at least one of the set of documents in order to identify at least one portion thereof as a potential answer. Additionally, the identifying a multiplicity of potential answers also includes, prior to the enhancing, generating an expected answer to the question, the expected answer including question keywords, and wherein the carrying out analysis includes carrying out theme extraction on the at least one of the set of documents, the theme extraction utilizing statistical analysis of the frequency of occurrence of words to identify at least one theme word of the at least one of the set of documents, which theme word may or may not be a question keyword, extracting sentences from the at least one of the set of documents, selecting at least one of the sentences as a potential answer if it fulfills at least one of the following criteria: a sentence including at least a predetermined plurality of question keywords and a sentence including at least one question keyword and at least one theme word, scoring each of the at least one of the sentences selected as a potential answer and identifying at least one of the sentences selected as a potential answer based at least partially on results of the scoring.

There is also provided in accordance with still another preferred embodiment of the present invention an answer extraction system including a computer operative to receive a question from a user, computerized answer extraction functionality operative to employ a computer network to access a set of documents relevant to the question by employing document search terms derived by the computer from the question, to extract at least one answer to the question and to provide the at least one answer to the user, the computerized answer extraction functionality being operative to identify a multiplicity of potential answers and to evaluate each of the multiplicity of potential answers according to at least one of the following criteria: proximity of question keywords in the potential answer, proximity of classification words and nouns in the potential answer and word count of at least part of the potential answer.

Alternatively, the computerized answer extraction functionality is operative to evaluate each of the multiplicity of potential answers according to at least two of the following criteria, all of the following criteria or a combination of the following criteria: proximity of question keywords in the potential answer, proximity of classification words and nouns in the potential answer and word count of at least part of the potential answer. Additionally, the computerized answer extraction functionality is operative to select a sub group of the multiplicity of potential answers based on an evaluation of the multiplicity of potential answers in accordance with the criteria.

Preferably, the evaluation includes scoring the multiplicity of potential answers in accordance with the criteria. Additionally, the answer extraction system also includes computerized potential answer combining functionality operative to form a potential answer document by combining the multiplicity of potential answers, computerized theme extraction functionality for carrying out theme extraction on the sub group of the multiplicity of potential answers, the theme extraction utilizing statistical analysis of the frequency of occurrence of words in the potential answer document to identify at least one theme word in the sub group of the multiplicity of potential answers, which theme word may or may not be a question keyword and computerized potential answer discarding functionality operative to discard potential answers belonging to the sub group of the multiplicity of potential answers which do not include at least one of the at least one theme word.

Preferably, the computerized theme extraction functionality includes computerized word stemming functionality, operative, for each word in the potential answers document, to stem the word to a corresponding root word, a word occurrence frequency score generator for generating a word occurrence frequency score for each different root word corresponding to a word in the potential answers document, computerized document word occurrence frequency indicating score calculating functionality operative to use the word occurrence frequency scores to calculate a document word occurrence frequency indicating score for the potential answers document and computerized word selecting functionality operative to select a subset of words in the potential answers document including at least one word having a word occurrence frequency score which is greater than or equal to the document word occurrence frequency indicating score.

Preferably, the computerized answer extraction functionality provides the at least one answer to the user in an order governed at least in part by at least one of a word count of each one of the at least one answer and a score, resulting from application to each one of the at least one answer of at least one of the following criteria: proximity of question keywords in the at least one answer, proximity of classification words and nouns in the at least one answer and word count of at least part of the at least one answer.

Preferably, the computerized answer extraction functionality includes computerized document analysis functionality operative to identify capitalized phrases which appear in at least one of the set of documents, to identify designated capitalized words belonging to the capitalized phrases and to add to the at least one of the set of documents, adjacent each occurrence of a designated capitalized word that does not appear in a capitalized phrase, the designated capitalized word that does appear alongside thereof elsewhere in the at least one of the set of documents in a capitalized phrase, thereby providing an enhanced document, and to carry out analysis of the enhanced document in order to identify at least one portion thereof as a potential answer.

There is further provided in accordance with yet another preferred embodiment of the present invention a document searching method including employing a computer to receive a query including at least one search term from a user and employing computerized synonym retrieving functionality operative in response to queries to generate document search terms including at least one additional search term not present in the query, the computerized synonym retrieving functionality being operative to generate the at least one additional search term by replacing at least one word in the query by at least one selected synonym thereof and operating computerized search engine functionality to access a set of documents in response to the query, based on at least one of the at least one search term supplied by a user and the at least one additional search term provided by the computerized synonym retrieving functionality, the computerized synonym retrieving functionality being operative to identify the at least one selected synonym at least partially by reference to at least one word in the query other than the at least one word.

Preferably, the computerized synonym retrieving functionality is operative to identify the at least one selected synonym by identifying a plurality of synonyms and selecting at least one of the plurality of synonyms for which there exists a phrase relevant to the query in a corpus. Additionally, the computerized synonym retrieving functionality or the synonym selector is operative to identify the selected synonym by searching the corpus for occurrences of the at least one of the plurality of synonyms for which there exists a phrase relevant to the query and designating at least one of the plurality of synonyms as a selected synonym in accordance with the number of occurrences in the corpus of a phrase including the at least one of the plurality of synonyms which is relevant to the query.

Preferably, the at least one word in the query which is replaced by the at least one selected synonym thereof includes at least one of a noun, a verb, an object of a verb and a subject of a verb.

There is still further provided in accordance with yet another preferred embodiment of the present invention a document searching system including a computer operative to receive a query including at least one search term from a user, computerized synonym retrieving functionality operative, in response to queries, to generate document search terms, including at least one additional search term not present in the query and to generate the at least one additional search term by replacing at least one word in the query by at least one selected synonym thereof and computerized search engine functionality operative to access a set of documents in response to the query, based on at least one of the at least one search term supplied by a user and the at least one additional search term provided by the computerized synonym retrieving functionality, the computerized synonym retrieving functionality being operative to identify the selected synonym at least partially by reference to a word in the query other than the at least one word.

Preferably, the computerized synonym retrieving functionality includes a synonym selector operative to identify a plurality of synonyms and to select at least one of the plurality of synonyms for which there exists a phrase relevant to the query in a corpus.

There is even further provided in accordance with still another preferred embodiment of the present invention a computerized synonym generating method including receiving a stream of words, employing a computer for generating a list of synonyms for at least one word in the stream of words, employing a computer for searching a corpus for synonym-containing phrases including at least one synonym in the list of synonyms together with at least part of the stream of words, employing a computer for evaluating the frequency of occurrence of each of the synonym-containing phrases and proposing at least one selected synonym which forms part of a synonym-containing phrase having a relatively high frequency of occurrence in the corpus.

Preferably, the computerized synonym generating method also includes employing a computer for searching the corpus for received phrases including the at least one word together with the at least part of the stream of words, employing a computer for comparing the frequency of occurrence of the received phrases in the corpus with the frequency of occurrence of the synonym-containing phrases and proposing at least one selected synonym which forms part of a synonym-containing phrase only if the frequency of occurrence of the synonym-containing phrase exceeds the frequency of occurrence of the received phrase. Additionally, the at least one word includes at least one of a noun, a verb, an object of a verb and a subject of a verb.

There is also provided in accordance with another preferred embodiment of the present invention a computerized synonym generating system including a computer operative to generate a list of synonyms for at least one word in a stream of words received from a user, computerized searching functionality operative to search a corpus for synonym-containing phrases including at least one synonym in the list of synonyms together with at least part of the stream of words, computerized frequency evaluation functionality operative to evaluate the frequency of occurrence of each of the synonym-containing phrases and computerized synonym providing functionality operative to propose at least one selected synonym which forms part of a synonym-containing phrase having a relatively high frequency of occurrence in the corpus.

Preferably, the computerized synonym generating system also includes computerized received phrases searching functionality operative to search the corpus for received phrases including the at least one word together with the at least part of the stream of words and computerized occurrence frequency comparing functionality operative to compare the frequency of occurrence of the received phrases in the corpus with the frequency of occurrence of the synonym-containing phrases, the computerized synonym providing functionality being operative to propose at least one selected synonym which forms part of a synonym-containing phrase only if the frequency of occurrence of the synonym-containing phrase exceeds the frequency of occurrence of the received phrase.

There is further provided in accordance with still another preferred embodiment of the present invention a computerized question generation method including identifying at least one theme word in a document, searching for previously asked questions containing the at least one theme word or having previously generated answers containing the at least one theme word and presenting the previously asked questions.

Preferably, the computerized question generation method also includes, prior to the identifying, employing a computer to obtain the document from a user, and the presenting includes presenting the previously asked questions on the computer to the user. Additionally or alternatively, the identifying includes carrying out statistical analysis of the frequency of occurrence of words in the document.

Preferably, the carrying out statistical analysis includes for each word in the document, stemming the word to a corresponding root word, generating a word occurrence frequency score for each different root word corresponding to a word in the document, using the word occurrence frequency scores to calculate a document word occurrence frequency indicating score for the document and selecting a subset of words in the document including at least one word having a word occurrence frequency score which is greater than or equal to at least the document word occurrence frequency indicating score.

There is yet further provided in accordance with yet another preferred embodiment of the present invention a computerized question generation system including computerized theme word identifying functionality for identifying at least one theme word in a document, computerized previous answer searching functionality operative to search for previously asked questions containing the at least one theme word or having previously generated answers containing the at least one theme word, and an output device for providing the previously asked questions.

Preferably, the computerized theme word identifying functionality is operative to carry out statistical analysis of the frequency of occurrence of words in the document.

There is also provided in accordance with another preferred embodiment of the present invention a computerized editable report precursor generating method including inputting at least one question into a computer, employing the computer to obtain at least one answer to the at least one question, storing the at least one answer to the at least one question, presenting the at least one question to the at least one answer in an editable form on the computer as an editable report precursor, archiving a multiplicity of the editable report precursors and following the archiving, employing the multiplicity of editable report precursors to enhance the employing the computer.

Preferably, the archiving includes archiving edited versions of the multiplicity of editable report precursors and the edited versions are also employed to enhance the employing the computer. Additionally, the inputting includes inputting the at least one question to the computer by at least one of typing the question, using a voice responsive input device, using a screen scraping functionality, using an email functionality, using an SMS functionality and using an instant messaging functionality.

Preferably, the employing the computer includes employing computerized answer retrieving functionality to generate document search terms including at least one additional search term not present in the question, which the additional search term was acquired, prior to receipt by the computer of the question from the user, by the computerized answer retrieving functionality in response to the at least one question and operating computerized search engine functionality to access a set of documents in response to the question, based not only on at least one search term supplied by a user but also on the at least one additional search term provided by the at least one computerized answer retrieving functionality.

There is yet further provided in accordance with still another preferred embodiment of the present invention a computerized editable report precursor generating method including inputting at least one desired report subject identifier into a computer, employing the computer to generate at least one question related to a desired subject identified by the at least one desired report subject identifier, employing the computer to obtain at least one answer to the at least one question and presenting the at least one question to the at least one answer in an editable form on the computer, thereby providing an editable report precursor.

Preferably, the computerized editable report precursor generating method also includes archiving a multiplicity of the editable report precursors and following the archiving, employing the multiplicity of editable report precursors to enhance at least one of the employing the computer to generate at least one question and the employing the computer to obtain at least one answer to the at least one question. Additionally or alternatively, the archiving includes archiving edited versions of the multiplicity of editable report precursors and wherein the edited versions are also employed to enhance at least one of the employing the computer to generate at least one question and the employing the computer to obtain at least one answer to the at least one question.

Preferably, the inputting includes inputting the at least desired report subject identifier to the computer by at least one of typing the desired report subject identifier, using a voice responsive input device, using a screen scraping functionality, using an email functionality, using an SMS functionality and using an instant messaging functionality.

Preferably, the employing the computer to generate the at least one question includes employing the desirable report subject identifier to search for previously asked questions containing at least part of the desirable report subject identifier or having previously generated answers containing at least part of the desirable report subject identifier.

Preferably, the employing the computer includes employing computerized answer retrieving functionality to generate document search terms including at least one additional search term not present in the question, which the additional search term was acquired, prior to receipt by the computer of the desired report subject identifier from the user, by the computerized answer retrieving functionality in response to at least one query, operating computerized search engine functionality to access a set of documents in response to the question, based not only on the desired report subject identifier but also on the at least one additional search term provided by the at least one computerized answer retrieving functionality.

### BRIEF DESCRIPTION OF THE DRAWINGS

The present invention will be understood and appreciated more fully from the following detailed description, taken in conjunction with the drawings in which:

FIG. 1 is a simplified illustration of document searching functionality operative in accordance with a preferred embodiment of the present invention;

FIG. 2 is a simplified flow chart of the document searching functionality of FIG. 1;

FIG. 3 is a simplified flow chart of answer extraction methodology which forms part of the document searching functionality of FIGS. 1 & 2;

FIG. 4 is a simplified illustration of a question generating functionality operative in accordance with another preferred embodiment of the present invention;

FIG. 5 is a simplified flow chart of the question generating functionality of FIG. 4; and

FIG. 6 is a simplified illustration of report precursor-generating functionality operative in accordance with yet another preferred embodiment of the present invention.

### DETAILED DESCRIPTION OF A PREFERRED EMBODIMENT

Throughout the specification and claims, certain defined terms have specific meanings as set forth hereinbelow:

Stopwords are defined as very common words which are useless in searching or indexing documents. Stopwords generally include articles, adverbials and adpositions. Some obvious stopwords are “a”, “of”, “the”, “I”, “it”, “you”, and “and”.

Keywords are defined as all the words in a sentence or phrase, such as in a question or other query, that are not stopwords. Keywords generally include all the nouns in a sentence or phrase, as well as verbs and adjectives.

Question Keywords and Query Keywords are Keywords that appear in a question or query.

Phrases are defined as a collection of words.

Throughout, phrases, indicated by inclusion in quotation marks “ ”, are processed by a computerized methodology as complete phrases. Other collections of words, such as those joined by symbols such as + and & are processed by the computerized methodology as separate terms connected by Boolean operators.

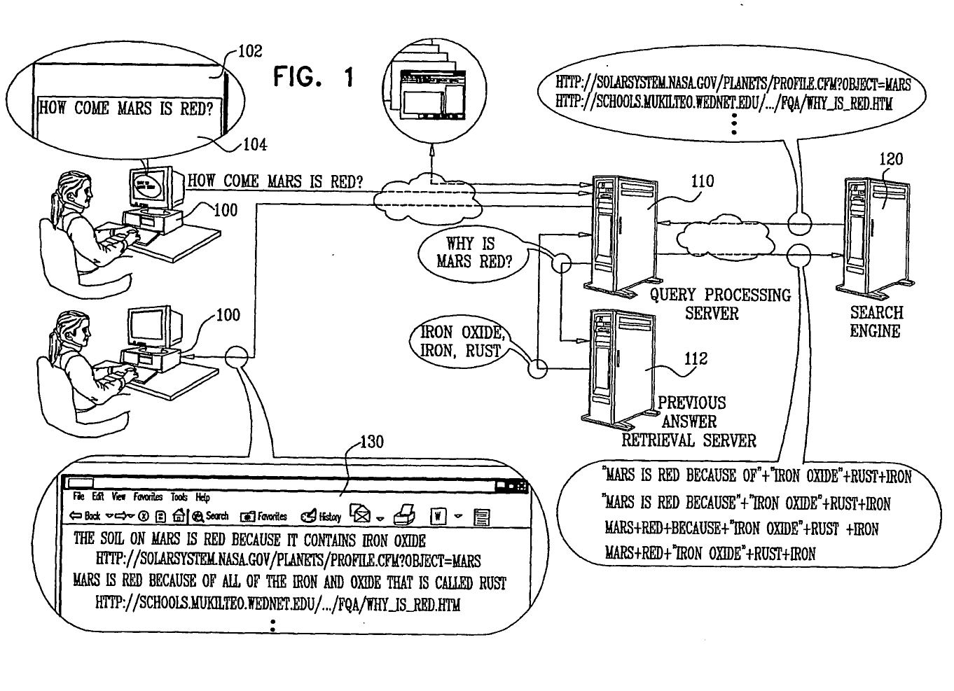

Reference is now made to FIG. 1, which is a simplified illustration of a typical document searching methodology operative in accordance with a preferred embodiment of the present invention. As seen in FIG. 1, a user operating a client computer 100, employs a conventional web browser such as Microsoft® Internet Explorer® to access a web page 102 containing a search input box 104. The user enters a query, preferably a question such as “HOW COME MARS IS RED?”, in the search input box 104.

Alternatively, any other suitable methodology may be employed for entering the query, such as the use of a voice responsive input device, a screen scraping functionality, an email functionality, an SMS functionality or an instant messaging functionality.

The question is supplied, typically via the Internet, to a query processing server 110, which normalizes the question, as described hereinbelow in greater detail, and provides a normalized question output, such as “WHY IS MARS RED?”.

In accordance with a preferred embodiment of the present invention, as part of the normalizing functionality, server 110 is operative in response to generate document search terms including at least one additional search term not present in a query by replacing at least one word in the query by at least one selected synonym thereof.

In accordance with a preferred embodiment of the present invention, the normalized question output is supplied to a previous answer retrieval server 112, which provides an output of keywords previously given in answers to the same question or a similar question. However, it is possible that such keywords will not be found. It is appreciated that the functionality of server 112 may be carried out by server 110, thus obviating server 112.

The output of server 112 may typically be a string of words or phrases such as IRON OXIDE, RUST and IRON.

Server 110 generates at least one expected answer to the question and on the basis of the expected answer generates a plurality of preliminary search engine queries, such as “MARS IS RED BECAUSE OF”, “MARS IS RED BECAUSE”, MARS+RED+BECAUSE AND MARS+RED.

In accordance with a preferred embodiment of the present invention, server 110 concatenates the preliminary search engine queries with the outputs of server 112, thus providing a plurality of concatenated search engine queries, typically:

### “MARS IS RED BECAUSE OF”+“IRON OXIDE”+RUST+IRON;

### “MARS IS RED BECAUSE”+“IRON OXIDE”+RUST+IRON;

### MARS+RED+BECAUSE+“IRON OXIDE”+RUST+IRON; and

### MARS+RED+“IRON OXIDE”+RUST+IRON.

Server 110 communicates via the Internet with a conventional search engine server 120, such as an Answers.com™, GOOGLE® or YAHOO® server, which performs a web search in accordance with the concatenated search engine queries. The search engine server typically provides search results to server 110 in the form of links to relevant documents, such as the following links:

http://solarsystem.nasa.gov/planets/profile.cfm?Object=Mars&Display=Kids
http://schools.mukliteo.wednet.edu/me/staff/bullocksk/FQA/why_is_red.htm

It is appreciated that the functionality of search engine server 120 may be carried out by using a local search engine index located on server 110, thus obviating server 120.

Server 110 retrieves the documents identified by the links received from the search engine server 120. In accordance with a preferred embodiment of the present invention, server 110 carries out answer extraction including, inter alia the following functionality:

Extracting at least one answer to a question by generating an expected answer to the question, where the expected answer includes question keywords; analyzing the documents identified by the search engine by carrying out theme extraction on plural ones of the set of documents; and extracting sentences from plural ones of the set of documents. The theme extraction utilizes statistical analysis of the frequency of occurrence of words to identify at least one theme word of a document, which may or may not be a question keyword.

Selecting at least one of the sentences as a potential answer if it fulfills at least one of the following criteria: a sentence including at least a predetermined plurality of question keywords and a sentence including at least one question keyword and at least one theme word.

Scoring each sentence selected as a potential answer; and

Identifying at least one of the sentences selected as a potential answer based at least partially on results of the scorings.

Additionally or alternatively, in accordance with a preferred embodiment of the present invention, server 110 carries out answer extraction including, inter alia the following functionality:

Extracting at least one answer to the question by analyzing the set of documents. The set of documents is analyzed by enhancing each document in the set by identifying capitalized phrases which appear in the document, identifying designated capitalized words belonging to the capitalized phrases and adding to the document adjacent each designated capitalized word that does not appear in a capitalized phrase, the designated capitalized word that does appear alongside thereof elsewhere in the document in a capitalized phrase; and

Carrying out analysis of the enhanced document in order to identify at least one portion thereof as a potential answer.

Additionally or alternatively, in accordance with a preferred embodiment of the present invention, server 110 carries out potential answer ranking among multiple potential answers, including, inter alia, identifying a multiplicity of potential answers and evaluating each of a multiplicity of potential answers according to at least one of the following criteria:

proximity of question keywords in the potential answer;

proximity of classification words and nouns in the potential answer; and

word count of at least part of the potential answer.

Server 110 preferably provides multiple “best” answers to the user via the Internet and the user's computer 100. Typical “best” answers are:

### THE SOIL ON MARS IS RED BECAUSE IT CONTAINS IRON OXIDE

### MARS IS RED BECAUSE OF ALL OF THE IRON AND OXIDE THAT IS CALLED RUST.

The “best” answers may be combined and presented to the user in any suitable format, such as in an editable report precursor format 130. Such a format allows the user to manipulate, annotate and edit multiple answers so as to create a report based thereon. If desired, “best” answers to multiple questions may be combined in a single editable report precursor format.

It is appreciated that the computerized document searching functionality described hereinabove with reference to FIG. 1 utilizes artificial intelligence.

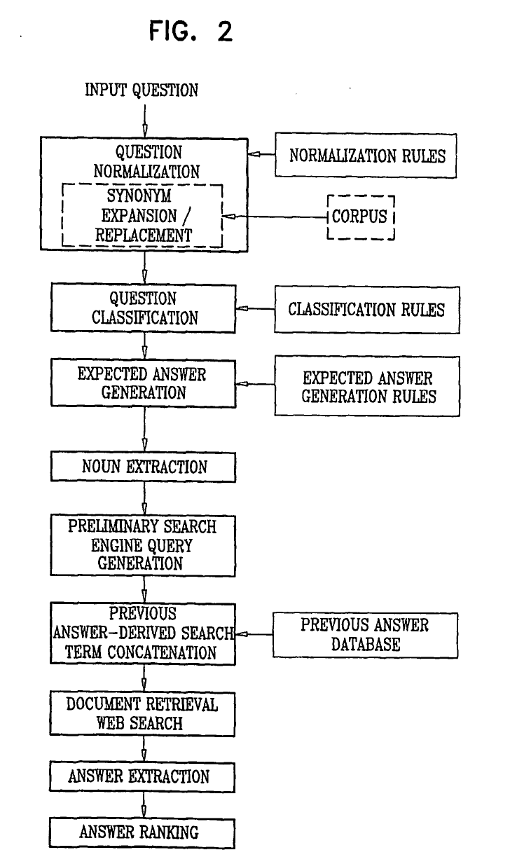

Reference is now made to FIG. 2, which is a simplified flow chart of the document searching methodology of FIG. 1. As seen in FIG. 2, a user's input question is typically received from client computer 100 (FIG. 1) which employs a conventional web browser such as Microsoft® Internet Explorer®.

It is appreciated that an input question is one example of an input query, which need not necessarily be a question. Examples of input queries which are not questions are: “CAPITAL OF OHIO”, “ABRAHAM LINCOLN'S SECRETARY OF STATE” and “MAXIMUM DEPTH OF THE PACIFIC OCEAN”. For the sake of simplicity and conciseness, most of the description of the present invention is provided in the context of a query which is a question, although the present invention is not limited to queries which are questions. It is appreciated that some, most or all of the functionality of the present invention may be carried out by a single computer, which may be the client computer 100. Such a single-computer embodiment is not presently believed to be the preferred embodiment of the invention and accordingly, the invention is described herein in a multi-computer environment.

The question is normalized, typically by query processing server 110 (FIG. 1). Normalization takes place based on a predefined set of normalization rules, which can be, for example, hard-coded or stored in a look-up table. A preferred set of normalization rules appear in Table 1.

TABLE 1

| Initial phrase | Normalized phrase |
|---|---|
| which | What |
| whats | what is |
| what's | what is |
| whens | when is |
| when's | when is |
| how many people live in | what is the population of |
| how many people are in | what is the population of |
| how many people are there in | what is the population of |
| people live in | population |
| what nationality | where was born |
| how rich is | how much money |
| what month | When |
| what year | When |
| what day | When |
| explain the | what is the |
| explain | what is |
| color is | color of |
| colour is | colour of |
| what fraction | what percent |
| what nationality | where was born |
| how rich is | how much money |
| how much is a | how much is a cost |
| how tall | how tall height |
| Date of birth | born |
| Long, live | lifespan |
| life span | lifespan |
| can you explain | what is |
| could you explain | what is |
| what is the reason | why |
| How far is | what is the distance to |
| How far away is | what is the distance to |
| color | color |
| brain boost | brainboost |
| how old is | when was born |
| what happens when | why does |
| what happens | why |
| how big is | what is the area of |
| percentage | percent |
| world war two | world war II |
| world war three | world war III |
| this year | 2005 |
| next year | 2006 |
| brain boost | brainboost |
| how old is | when was born |
| how wide | how wide width |
| how deep | how deep depth |

Preferably, the normalization rules are formulated in order to provide standardization which enhances the efficiency of the methodology of the present invention.

Examples of operation of normalization functionality include conversion of:

“what's” to —what is—;
“people live in” to —population—;
“how come” to —why—; and
“what year”, “what month” and “what day” to —when—.

Queries which are not formulated by the user in question syntax are converted to question syntax. For example:

“CAPITAL OF MASSACHUSETTS” is converted to —WHAT IS THE CAPITAL OF MASSACHUSETTS—.
“LENGTH OF BROOKLYN BRIDGE” is converted to —WHAT IS THE LENGTH OF THE BROOKLYN BRIDGE—

In the example of FIG. 1, the input question “HOW COME MARS IS RED” is converted to —WHY IS MARS RED?—

In accordance with a preferred embodiment of the present invention, question normalization also preferably includes synonym expansion and/or replacement. Preferably synonym expansion and/or replacement employs synonym retrieving functionality, preferably provided by server 110. The synonym retrieving functionality is preferably operative in response to questions to generate document search terms including at least one additional search term not present in the question and to generate the at least one additional search term by replacing at least one word in the question by at least one selected synonym thereof. In accordance with a preferred embodiment of the present invention, the synonym retrieving functionality is operative to identify the at least one selected synonym at least partially by reference to a word in the question other than the at least one word which is replaced by the synonym. The at least one additional search term may be employed in place of or in addition to the search term defined by the question.

Preferably, the synonym retrieving functionality is operative to identify the selected synonym by identifying a plurality of synonyms and selecting at least one of the plurality of synonyms for which there exists a phrase relevant to the question in a corpus.

In accordance with a preferred embodiment of the present invention the synonym retrieving functionality is operative to identify the selected synonym by:
Searching a corpus for occurrences of at least one of the plurality of synonyms for which there exists a phrase relevant to the question; and

designating at least one synonym as a selected synonym in accordance with the number of occurrences in the corpus of a phrase including the synonym which is relevant to the question.

In accordance with an additional embodiment of the invention, the synonym generation functionality described hereinabove may have a context-based thesaurus application which could be outside of the context of document searching. In such an embodiment, there is provided computerized synonym generating functionality which is operative for:

receiving a stream of words;

employing a computer for generating a list of synonyms for at least one word in the stream of words;

employing a computer for searching a corpus for synonym-containing phrases including synonyms in the list of synonyms together with at least part of the stream of words;

employing a computer for evaluating the frequency of occurrence of each of the synonym-containing phrases; and

proposing at least one selected synonym which forms part of a synonym-containing phrase having a relatively high frequency of occurrence in the corpus.

Preferably the synonym generating functionality is also operative for:

employing a computer for searching the corpus for received phrases including the at least one word together with the at least part of the stream of words;

employing a computer for comparing the frequency of occurrence of the received phrases in the corpus as compared with the frequency of occurrence of the synonym-containing phrases; and

proposing at least one selected synonym which forms part of a synonym-containing phrase only if the frequency of occurrence of the synonym-containing phrase exceeds the frequency of occurrence of the received phrase.

Following question normalization, the results of the normalization functionality undergo question classification. Question classification functionality is operative to attempt to classify the question into at least one of a predetermined set of categories based on a predefined set of classification rules, which can be, for example, hard-coded or stored in a look-up table. A preferred set of classification rules appears in Table 2. It is appreciated that some questions do not fall into any one of the predetermined set of classification categories.

Examples of classification categories include:

Questions relating to date such as:

“WHEN WAS GROVER CLEVELAND BORN?”

Questions relating to length such as:

“HOW LONG IS THE MISSISSIPPI RIVER?”

Questions relating to color such as:

“WHAT COLOR IS NEPTUNE?”

TABLE 2

| | Question |
|---|---|
| Classification | words |
| how large | length |
| how big | length |
| how small | length |
| how high | length |
| what diameter | length |
| how parsecs | length |
| how light years | length |
| how m | length |
| how millimeters | length |
| how millimeter | length |
| how mm | length |
| how inches | length |
| how inch | length |
| how centimeters | length |
| how centimeter | length |
| how cm | length |
| how meters | length |
| how meter | length |
| how kilometers | length |
| how kilometer | length |
| how kmh | length |
| how feet | length |
| how foot | length |
| how ft | length |
| how yards | length |
| how yard | length |
| how yd | length |
| how miles | length |
| how mile | length |
| how mi | length |
| how mph | length |
| how k/m | length |
| how deep | length |
| how short | length |
| how tall | length |
| how taller | length |
| how large | length |
| how big | length |
| how small | length |
| how high | length |
| what diameter | length |
| how parsecs | length |
| how light years | length |
| how m | length |
| how millimeters | length |
| how wide | length |
| how shorter | length |
| how wider | length |
| how fast | length |
| how thick | length |
| how faster | length |
| what distance | length |
| how distance | length |
| what velocity | length |
| what depth | length |
| what length | length |
| what height | length |
| what width | length |
| what speed | length |
| what airspeed | length |
| what size | length |
| what area of | length |
| what elevation | length |
| what radius | length |
| what altitude | length |
| what thickness | length |
| how wide | length |
| how shorter | length |
| how wider | length |
| how fast | length |
| how thick | length |
| how faster | length |
| what distance | length |
| how distance | length |
| what velocity | length |
| what depth | length |
| what length | length |
| what height | length |
| what width | length |
| what speed | length |
| what airspeed | length |
| what size | length |
| what area of | length |
| what elevation | length |
| what radius | length |
| what altitude | length |
| what thickness | length |
| how wide | length |
| how shorter | length |
| how wider | length |
| how fast | length |
| how old | numeric |
| how many | numeric |
| how much | numeric |
| Lifespan | numeric |
| population | numeric |
| what planets | planet |
| what moons | planet |
| what planet | planet |
| what moon | planet |
| how old | numeric |
| how many | numeric |
| how much | numeric |
| what state matter | matter |
| what state | state |
| what states | state |
| what ocean | ocean |
| how big | big |
| how large | big |
| What phone number | phone |
| What telephone number | phone |
| what time | time |
| what hour | time |
| what hours | time |
| what organ | organ |
| what percent | percent |
| what percentage | percent |
| what country | country |
| what countries | country |
| what nation | country |
| what nations | country |
| which country | country |
| what color | color |
| what colors | color |
| how much time | duration |
| how often | duration |
| how long | long |
| what length | long |
| how far | long |
| how close | long |
| how farther | long |
| how longer | long |
| how grams | weight |
| how kilograms | weight |
| how kilogram | weight |
| how kg | weight |
| how tonnes | weight |
| how ounces | weight |
| how ounce | weight |
| how oz | weight |
| how pounds | weight |
| how pound | weight |
| how lbs | weight |
| how lb | weight |
| how weigh | weight |
| how heavy | weight |
| how heavier | weight |
| how light | weight |
| how lighter | weight |
| how much payload | weight |
| what weigh | weight |
| what atomic weight | numeric |
| what weight | weight |
| what mass | weight |
| what density | weight |
| How milliliters | volume |
| How milliliter | volume |
| How ml | volume |
| How liters | volume |
| How liter | volume |
| How pints | volume |
| How pint | volume |
| How pt | volume |
| How quarts | volume |
| How quart | volume |
| How qt | volume |
| How gallons | volume |
| How gallon | volume |
| How gal | volume |
| How teaspoons | volume |
| How teaspoon | volume |
| How tsp | volume |
| How tablespoons | volume |
| How tablespoon | volume |
| How tbsp | volume |
| how hot | temperature |
| how cold | temperature |
| how degrees | temperature |
| how degree | temperature |
| what temperature | temperature |
| how much pay | money |
| how much cost | money |
| how much money | money |
| how much spend | money |
| how much sold | money |
| how muchjpay | money |
| how much worth | money |
| how much profit | money |
| what price | money |
| what cost | money |
| what worth | money |
| what monetary value | money |
| When | date |
| what date | date |
| what day | date |
| what month | date |
| what year | date |
| what birthday | date |
| what birthdate | date |
| what frequency | frequency |
| who was the | who2 |
| who is the | who2 |
| who is | Who2 |
| Who | who2 |
| what is | define |
| Lifespan | numeric |

Following question classification, the normalized question, which may or may not be classified in one or more predetermined category, is employed for expected answer generation. Expected answer generation functionality is operative to generate expected answers to a normalized question based on a predefined set of expected answer generation rules, which can be, for example, hard-coded or stored in a look-up table.

Expected answer generation functionality reformats a normalized question into answer syntax likely to appear in the correct answer to the question. The expected answer generation rules preferably include substantially all verbs in a relevant language (e.g., English) as well as predefined conjugation rules. For example, where the phrase “why is” appears, the word “why” is removed, the word “is” is inserted before the last word of the query and the word “because” is added at the end of the entire string. As another example, where the phrase “why did” appears, the word “why” is removed and the verb is converted into the past tense.

For example, the question: WHEN WAS JOHN DOE BORN? is reformatted to —JOHN DOE WAS BORN ON . . . —

As a further example, the question: WHY DID THE VOLCANO ERUPT? is reformatted to —THE VOLCANO ERUPTED BECAUSE . . . —

In the example referenced in FIG. 1, the normalized question: WHY IS MARS RED? is reformatted to —MARS IS RED BECAUSE . . . —

Following expected answer generation, the expected answer undergoes noun extraction. Noun extraction is preferably carried out by initially tagging parts of speech in the expected answer, using a conventional part of speech tagger, such as the Brill Tagger, which is accessible, for example on www.cs jhu.edu/˜brill.

The noun extraction functionality then extracts all of the nouns in the expected answer.

In the example of FIG. 1, the extracted nouns are: MARS & RED.

Following noun extraction, the extracted nouns and the expected answer are supplied to preliminary search engine query generation functionality, which generates preliminary search engine queries based on the expected answer. Preliminary search engine query generation functionality preferably generates multiple preliminary search engine queries, typically four in number, in accordance with the following rules:

1. The expected answer received from expected answer generation functionality constitutes one of the preliminary search engine queries.

In the example of FIG. 1: “MARS IS RED BECAUSE OF”

2. A further preliminary search engine query is generated by removing stopwords from the beginning and end of the expected answer.

In the example of FIG. 1: “MARS IS RED BECAUSE”

3. An additional preliminary search engine query is generated by removing all of the stopwords from the expected answer.

In the example of FIG. 1: MARS+RED+BECAUSE

4. A further preliminary search engine query is generated by retaining only the nouns in the expected answer.

In the example of FIG. 1: MARS+RED

The preliminary search engine queries are then enhanced by previous answer-derived search term concatenation. Previous answer-derived search term concatenation generates at least one additional search term, not present in the question, based on at least one previous answer received by previous answer retrieval server 112 from a previous answer database, in response to the input question. The previous answer was earlier provided by query processing server 110 in response to an earlier relevant question, prior to receipt of the current question from the user.

In accordance with a preferred embodiment of the present invention, previous answer-derived search term concatenation is carried out by server 110 (FIG. 1), which concatenates the preliminary search engine queries with the outputs of server 112, thus providing a plurality of concatenated search engine queries based on the preliminary search engine queries with the addition of previous answer-derived search terms.

In the example of FIG. 1, where the preliminary search engine queries are:

### “MARS IS RED BECAUSE OF”;

### “MARS IS RED BECAUSE”;

### MARS+RED+BECAUSE; and

### MARS+RED

and the previous answer-derived search terms are: IRON OXIDE, RUST and IRON,
the concatenated search engine queries are preferably:

### “MARS IS RED BECAUSE OF”+“IRON OXIDE”+RUST+IRON;

### “MARS IS RED BECAUSE”+“IRON OXIDE”+RUST+IRON;

### MARS+RED+BECAUSE+“IRON OXIDE”+RUST+IRON; and

### MARS+RED+“IRON OXIDE”+RUST+IRON.

The concatenated search engine queries are preferably employed to perform a document retrieval web search, typically initiated by server 110 (FIG. 1) communicating via a network, such as the Internet, with conventional search engine server 120 (FIG. 1), such as an Answers.com™, GOOGLE® or YAHOO® server. Alternatively any other suitable search engine may be used to search specific domains of documents, such as news documents, business related documents and science related documents.

Searches of specific document domains may be manually or automatically actuated. In accordance with a preferred embodiment of the present invention, automatic actuation of a search in a specific document domain may be realized by comparing a query with trigger words which are highly specific to a specific document domain. For example, inquiries regarding “tsunami” can be directed automatically to a specific news document domain search engine, should the term “tsunami” be flagged as a current event item. Flagging of a current event item may be carried out manually or automatically by query processing server 110.

The search engine server 120 typically provides search results to server 110 in the form of links to relevant documents and summaries of those documents.

In the example of FIG. 1, the following typical links may be among the links supplied to server 110:

http://solarsystem.nasa.gov/planets/profile.cfm?Object=Mars&Display=Kids
http://schools.mukilteo.wednet.edu/me/staff/bullocksk/FQA/why_is_red.htm

The documents, such as HTML, WORD, XML and PDF documents, identified by the links, are automatically and concurrently downloaded.

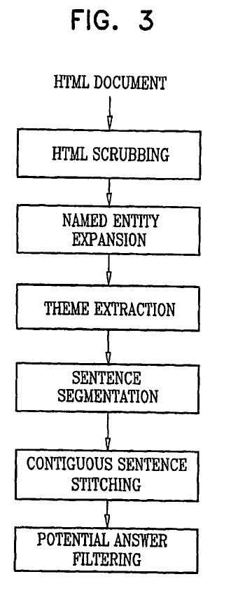

Each retrieved document is preferably processed by answer extraction functionality, which is now described with reference to FIG. 3 with reference to an HTML document. It is appreciated that other types of documents can be processed in a suitably similar manner.

As an initial step in answer extraction, the HTML document is subject to HTML scrubbing wherein the HTML document is converted to a text document by removing the HTML tags in a conventional manner.

Following HTML scrubbing, named entity expansion of the text document takes place.

In conceptual terms, named entity expansion involves the following functionality:

Enhancing a retrieved document by identifying capitalized phrases which appear in the document, identifying designated capitalized words belonging to the capitalized phrases and adding to the document adjacent each designated capitalized word that does not appear in a capitalized phrase, the designated capitalized word that does appear alongside thereof elsewhere in the document in a capitalized phrase; and

Carrying out analysis of the enhanced document in order to identify at least one portion thereof as a potential answer.

In accordance with a preferred embodiment of the present invention, all the proper nouns and proper noun containing phrases in the text document are identified. All such proper nouns and proper noun containing phrases in the text document are expanded into the largest noun phrase form that appears in the text. This is particularly useful in situations where the text contains an abbreviation of a proper noun, such as a person's name or the name of a place.

For example, if “Planet Mars”, “Mars”, “Red Planet”, “Red Planet Mars”, and “Red Mars” all appear in the text document, the shorter forms are all expanded to read: “Red Planet Mars”.

Preferably, the named entity expansion functionality carries out the following steps in software:

Step 1—Proper nouns and phrases containing proper nouns are extracted by executing a regular expression (([A-Z][\w|,]+\s)+) which extracts all capitalized words and phrases. Regular expressions of this type are well known in the art of computer programming.

Step 2—In order to reduce incorrect results, extracted proper nouns and phrases containing proper nouns having words that are all capitalized or having a total length greater than 75 characters in length are ignored.

Step 3—The extracted phrases are collected in an initial list.

Step 4—The largest entry corresponding to each entry, which is entirely contained in a larger entry, is identified.

Step 5—Entries in the initial list are expanded by replacing entries which are entirely contained in a larger entry, by the largest entry, thereby defining a “largest entries list”.

For example, for an initial list containing the following entries:

“Planet Mars”, “Mars”, “Red Planet”, “Red Planet Mars”, “Earth”, “Venus” and “Red Mars”,

the largest entries list preferably contains the following entries:

“Red Planet Mars”, “Red Planet Mars”, “Red Planet Mars”, “Red Planet Mars”, “Earth”, “Venus” and “Red Planet Mars”.

Using the initial list and the largest entries list, the named entity expansion functionality modifies the text document by replacing all proper nouns and phrases containing proper nouns in the initial list with the corresponding largest proper noun phrase appearing in the largest entries list.

Following named entity expansion, the modified text document undergoes theme extraction, providing a list of words ranked by their frequency of occurrence.

In conceptual terms, theme extraction utilizes statistical analysis of the frequency of occurrence of words in the modified text document to identify at least one theme word of the document, which theme word may or may not be a question keyword. Theme extraction enables answers to the question to be found in text which does not contain a question keyword.

For example, if in response to a question such as “HOW MUCH HORSEPOWER IN A MERCEDES S500?”, there is found a modified text document containing a sentence “THE 2000 S500 IS POWERED BY A 5.0—LITER V8 PUMPING OUT 302 HORSEPOWER”, theme extraction identifies the sentence as an answer to the question, notwithstanding that the word Mercedes does not appear therein. As will be described hereinbelow, theme extraction examines the modified text document and notes that it relates to Mercedes and thus assumes that the above sentence refers to a Mercedes S500 vehicle.

Theme extraction preferably includes the following steps:

Step 1—All non-alphanumeric characters are removed from the modified text document, preferably by replacing matches of the following regular expression with spaces:

[symbol]

Step 2—The resulting document is then rendered into a list of words.

Step 3—The following words are then removed from the list of words:
Stopwords—Examples are: “the”, “and” & “but”
Common words, which appear very often in the English language. These words are ignored since they probably have little significance to the overall document. Examples are: “because”, “teach”, “take”, “speak”, “simply” & “select”.
Words less than three characters in length.

Preferably numbers are not removed.

Step 4—The remaining words in the list are stemmed to their roots, preferably using known stemming algorithms, such as the well-known Porter-stemming algorithm. A list of stemmed words is formed.

Step 5—An occurrence frequency score is generated for every different word in the list of stemmed words, the occurrence frequency score indicating the occurrence of the word in the modified text document.

Step 6—Using the occurrence frequency score and knowing the number of different words in the modified text document, an average word occurrence frequency is calculated for the document. Alternatively a median word occurrence frequency may be provided.

For example, if the initial document contains the following text:

“Mars is fourth from the Sun. It is sometimes called the ‘Red Planet’ etc. because of the color of its soil. The soil on the Red Planet is red because much of the soil contains iron oxide (rust). Exploring Mars is a difficult, but worthwhile task. However there are many interesting things to see and learn. Olympus Mons may be the largest volcano in our solar system. It is three times taller than the tallest mountain on Earth, Mt. Everest.”

Following Named Entity Expansion, the modified text document contains the following text in which the expanded named entities are underlined here for the sake of clarity:

“Red Planet Mars is fourth from the Sun. It is sometimes called the ‘Red Planet Mars’ etc. because of the color of its soil. The soil on the Red Planet Mars is red because much of the soil contains iron oxide (rust). Exploring Red Planet Mars is a difficult, but worthwhile task. However there are many interesting things to see and learn. Olympus Mons may be the largest volcano in our solar system. It is three times taller than the tallest mountain on Earth, Mt. Everest.”

Following step 3 described hereinabove, the list of words is: “Red”, “Planet”, “Mars”, “fourth”, “sun”, “Red”, “Planet”, “Mars”, “etc.”, “color”, “soil”, “soil”, “Red”, “Planet”, “Mars”, “red”, “soil”, “iron”, “oxide”, “rust”, “Red”, “Planet”, “Mars”, “difficult”, “worthwhile”, “task”, “interesting”, “Olympus”, “Mons”, “largest”, “volcano”, “solar”, “system”, “three”, “mountain”, “Earth”, “Everest”.

Following stemming as described in step 4, the list of stemmed words is:

“Red”, “Planet”, “Mars”, “four”, “planet”, “sun”, “Red”, “Planet”, “Mars”, “etc.”, “color”, “soil”, “soil”, “Red”, “Planet”, “Mars”, “red”, “soil”, “iron”, “oxide”, “rust”, “Red”, “Planet”, “Mars”, “difficult”, “worthwhile”, “task”, “interest”, “Olympus”, “Mons”, “large”, “volcano”, “solar”, “system”, “three”, “mountain”, “Earth”, “Everest”.

The occurrence frequency score for each of the words in the list is:

“red”—5

“planet”—4

“Mars”—4

“four”—1

“sun”—1

“etc.”—1

“color”—1

“soil”—3

“iron”—1

“oxide”—1

“rust”—1

“difficult”—1

“worthwhile”—1

“task”—1

“interest”—1

“Olympus”—1

“Mons”—1

“large”—1

“volcano”—1

“solar”—1

“system”—1

“three”—1

“mountain”—1

“earth”—1

“Everest”—1

The average word occurrence frequency for this document is 1.48.

Preferably, all words having occurrence frequencies which are less than two times the average word occurrence frequency are discarded.

In the above example, the remaining word list is:

“red”—5

“planet”—4

“Mars”—4

“soil”—3

A second average word occurrence frequency is calculated for the remaining words. In the above example the second average word occurrence frequency is 4.

Words having occurrence frequencies that are equal to or greater than the second average word occurrence frequency are defined to be “Theme Words”.

The Theme Words are then arranged in the order of their occurrence frequencies in a list, termed a Theme Word List.

For the above example, the Theme Word List preferably appears as:

“red”, “planet”, “Mars”.

Following theme extraction, sentence segmentation takes place by breaking the modified text document into sentences by identifying periods while ignoring periods which are associated with common abbreviations. Examples of such common abbreviations having periods are “Mrs.”, “Mr.”, “Ltd.”, “etc.”, “Corp.” and “Atty.”.

In the above example, the Modified Text Document is:

“Red Planet Mars is fourth from the Sun. It is sometimes called the ‘Red Planet Mars’ etc. because of the color of its soil. The soil on the Red Planet Mars is red because much of the soil contains iron oxide (rust). Exploring Red Planet Mars is a difficult, but worthwhile task. However there are many interesting things to see and learn. Olympus Mons may be the largest volcano in our solar system. It is three times taller than the tallest mountain on Earth, Mt. Everest.”

Following sentence segmentation, the document appears as follows:

Sentence 1—Red Planet Mars is fourth from the Sun.
Sentence 2—It is sometimes called the ‘Red Planet Mars’ etc. because of the color of its soil.
Sentence 3—The soil on the Red Planet Mars is red because much of the soil contains iron oxide (rust).
Sentence 4—Exploring Red Planet Mars is a difficult, but worthwhile task.
Sentence 5—However there are many interesting things to see and learn.
Sentence 6—Olympus Mons may be the largest volcano in our solar system.
Sentence 7—It is three times taller than the tallest mountain on Earth, Mt. Everest.

Following sentence segmentation, contiguous sentence stitching is performed. Contiguous sentence stitching joins related contiguous sentences into related sentence units. Preferably contiguous sentence stitching is carried out by the following series of steps:

Step 1—The document is received in the form of a list of sentences.

Step 2—Working in reverse order, starting with the last sentence, the first word of each sentence is checked to determine whether it is a joining word

Step 3—If the first word of the sentence is a joining word, that sentence is appended to the end of the preceding sentence as a single related sentence unit.

Preferably, the first word in each sentence may or may not be identified as a joining word by consulting a look-up-table. Examples of joining words are some pronouns, such as “he”, “she” and “it” and words which indicate a time sequence, such as, for example: “before,” “after,” “beforehand,” and “afterwards”.

Referring to the preceding example, contiguous sentence stitching preferably converts the above-listed seven sentences into four related sentence units, preferably as follows:

1—Red Planet Mars is fourth from the Sun. It is sometimes called the ‘Red Planet Mars’ etc. because of the color of its soil.
2—The soil on the Red Planet Mars is red because much of the soil contains iron oxide (rust).
3—Exploring Red Planet Mars is a difficult, but worthwhile task. However there are many interesting things to see and learn.
4—Olympus Mons may be the largest volcano in our solar system. It is three times taller than the tallest mountain on Earth, Mt. Everest.

In accordance with a preferred embodiment of the invention, potential answer filtering is performed on all of the related sentence units. Potential answer filtering is preferably effected by comparing each of the related sentence units with each of the phrases in concatenated search engine queries containing a phrase and classifying each of the related sentence units as to whether it contains the phrase in a concatenated search engine query.

If a related sentence unit is found to contain the phrase in a concatenated search engine query and if the concatenated search engine query was derived from a question which is within one of the classification categories, the related sentence unit is examined to determine whether it contains a classification word which is appropriate to that category.

For example if the question was classified into a date category, the related sentence unit is examined to ensure that it contains a date.

Thereafter, the proximity between the phrase and the date in the related sentence unit is examined. Typically if there are more than a predetermined number of characters, for example 85 characters, between the phrase and the date, the related sentence unit is not considered to be a potential answer.

As another example, if the question was classified into a numerical answer category, such as a length category, the related sentence unit is examined to determine whether a number is present, either in digits or words.

In the present example, the phrase “MARS IS RED BECAUSE” appears in the concatenated search engine query generated according to rule 2 and also appears in related sentence unit 2—“The soil on the Red Planet Mars is red because much of the soil contains iron oxide (rust).”

If a potential answer is not identified by this stage, a noun question keyword based search of the related sentence units takes place, preferably employing the concatenated search engine query made up of noun question keywords, which was generated in accordance with rule 4 of the Preliminary Search Engine Query Generation rules described hereinabove, such as MARS+RED+“IRON OXIDE”+IRON+RUST.

If noun question keywords are found in multiple related sentence units, the noun question keyword containing related sentence units are ranked in accordance with the number of noun question keywords found.

In the present example, results of a noun question keyword search of the related sentence units produces the underlined results and rankings:

1—Red Planet Mars is fourth from the Sun. It is sometimes called the ‘Red Planet Mars’ etc. because of the color of its soil. Ranking—2
2—The soil on the Red Planet Mars is red because much of the soil contains iron oxide (rust?. Ranking—4
3—Exploring Red Planet Mars is a difficult, but worthwhile task. However there are many interesting things to see and learn. Ranking—2
4—Olympus Mons may be the largest volcano in our solar system. It is three times taller than the tallest mountain on Earth, Mt. Everest. Ranking—0

A question keyword based search of the related sentence units now takes place, preferably employing the concatenated search engine query made up of question keywords, which was generated in accordance with rule 3 of the Preliminary Search Engine Query Generation rules described hereinabove, such as MARS+RED+BECAUSE+“IRON OXIDE”+IRON+RUST.

If question keywords are found in multiple related sentence units, the question keyword containing related sentence units are ranked in accordance with the number of question keywords found.

In the present example, results of a question keyword search of the related sentence units produces the underlined results and rankings:

1—Red Planet Mars is fourth from the Sun. It is sometimes called the ‘Red Planet Mars’ etc. because of the color of its soil. Ranking—3
2—The soil on the Red Planet Mars is red because much of the soil contains iron oxide (rust). Ranking—5
3—Exploring Red Planet Mars is a difficult, but worthwhile task. However there are many interesting things to see and learn. Ranting—2
4—Olympus Mons may be the largest volcano in our solar system. It is three times taller than the tallest mountain on Earth, Mt. Everest. Ranking—0

The ranked question keyword containing related sentence units are then reranked in order to take into account questions keywords which do not appear in a given ranked related sentence unit but which do appear as theme words of the modified text document.

In the present example employing a noun question keyword search, results of reranking produces the following ranking. Theme words which are not question keywords are indicated by italics:

1—Red Planet Mars is fourth from the Sun. It is sometimes called the ‘Red Planet Mars’ etc. because of the color of its soil. Ranking—3

2—The soil on the Red Planet Mars is red because much of the soil contains iron oxide (rust). Ranking—5
3—Exploring Red Planet Mars is a difficult, but worthwhile task. However there are many interesting things to see and learn. Raking—3
4—Olympus Mons may be the largest volcano in our solar system. It is three times taller than the tallest mountain on Earth, Mt. Everest. Raning—0

The ranked question keyword-containing related sentence units are then examined as follows:

If a ranked related sentence unit is found to contain a question keyword in a concatenated search engine query and if the concatenated search engine query was derived from a question which is within one of the classification categories, the ranked related sentence unit is examined to determine whether it contains a classification word which is appropriate to that category.

For example, if the question was classified into a date category, the ranked related sentence unit is examined to ensure that it contains a date.

Thereafter, the proximity between a question keyword and the date in the related sentence unit is examined. Typically, if there are more than a predetermined number of characters, for example 85 characters, between the question keyword and the date, the ranked related sentence unit is not considered to be a potential answer.

As another example, if the question was classified into a numerical answer category, such as a length category, the related sentence unit is examined to determine whether a number is present, either in digits or words.

Preferably, only the related sentence unit or units having the highest ranking are retained.

In the present example employing a noun question keyword search, the following related sentence units, having the highest ranking are retained:

2—The soil on the Red Planet Mars is red because much of the soil contains iron oxide (rust). Ranking—5

It is a particular feature of the present invention that preferably the related sentence unit or units are then ranked on the basis of the number of question keywords appearing in a sentence or sentences corresponding thereto in the text document upstream of named entity expansion. Only the related sentence unit or units having the highest ranking are retained and are considered to be potential answers.

In the present example, related sentence unit 2 is retained, the word Mars is ignored and the related sentence unit 2 is reranked without taking into account the word Mars, which did not appear in the initial text document.

2—The soil on the Red Planet Mars is red because much of the soil contains iron oxide (rust). Ranking—4

The potential answers are then scored in accordance with the conciseness of the appearance of question keywords therein, and ranked in accordance with the score. This is achieved by examining each of the potential answers and determining the proximity between the question keywords therein. This examination preferably includes the following steps:

Step 1—Removal of stop words and all non-alphanumeric characters from each potential answer to provide a skeleton potential answer.

In the present example, the skeleton potential answers are:

2—soil Red Planet Mars red because soil contains iron oxide rust

Step 2—Noting the position of the question keywords in the skeleton potential answer;

In the present example, the positions are indicated in parentheses alongside each question keyword as follows:

2—soil Red Planet Mars(17) red(22) because soil contains iron oxide rust

Step 3—Calculating the average distance in characters of the question keywords from the beginning of the skeleton potential answer.

In the present example

2. Average distance=(17+22)/2=19.5

Step 4—Noting, for each different question keyword, the difference between the average distance and the location of the question keyword which is closest to the average distance.

In the present example:

2. For MARS, the difference is 19.5−17=2.5; for RED, the difference is 22−19.5=2.5

Step 5—Noting, for each potential answer, the spread between the difference of the question keyword having the greatest difference and the difference of the question keyword having the smallest difference.

For a case in which the difference of the question keyword having the greatest difference is equal to the difference of the question keyword having the smallest difference and the spread is zero, the spread is defined to be the difference of the question keyword having the greatest difference from the average.

In the present example:

### 2. Spread=2.5

The conciseness score which indicates the conciseness of the appearance of question keywords is defined to be the value of the spread. Ranking of the potential answers is a negative function of the score, such that a potential answer having a smaller score will be ranked higher.

For each document, the potential answers, each having a corresponding question keyword conciseness score, are supplied to answer ranking functionality (FIG. 2).

Answer ranking takes all of the potential answers from all of the modified text documents and generates a set of “best” answers. The answer ranking functionality preferably is operative for evaluating each of the potential answers according to at least one of the following criteria:

proximity of question keywords in the potential answer;

proximity of classification words and nouns in the potential answer; and

word count of at least part of the potential answer.

In accordance with a preferred embodiment of the invention, “best” answer filtering is performed on all of the potential answers. “Best” answer filtering is effected preferably by comparing each of the potential answers with each of the concatenated search engine queries that is a phrase and classifying each of the potential answers as to whether it contains the phrase in the concatenated search engine query defined by rule 1 above and possibly the phrase in the concatenated search engine query defined by rule 2 above.

If a predetermined number of “best” answers, preferably three, each containing the phrase in the concatenated search engine query defined by rule 1 above are found, then all potential answers not containing the phrase in the concatenated search engine query defined by rule 1 are discarded.

If a predetermined number of “best” answers, preferably two, each containing the phrase in the concatenated search engine query defined by rule 2 above are found, then all potential answers not containing the phrase in the concatenated search engine query defined by rule 1 or the phrase in the concatenated search engine query defined by rule 2 are discarded.

If neither of the above two conditions is fulfilled, a noun question keyword based search of the potential answers takes place, preferably employing the concatenated search engine query made up of noun question keywords, which was generated in accordance with rule 4 of the Preliminary Search Engine Query Generation rules described hereinabove, in a manner similar to that described hereinabove with reference to potential answer filtering in FIG. 3.

If noun question keywords are found in multiple potential answers, the noun question keyword containing potential answers are ranked in accordance with the number of noun question keywords found.

The potential answer or answers having the highest ranking are retained and are considered to be “best answers” and all other potential answers are discarded.

If a “best” answer is not identified by this stage, a question keyword based search of the potential answers takes place, preferably employing the concatenated search engine query made up of question keywords, which was generated in accordance with rule 3 of the Preliminary Search Engine Query Generation rules described hereinabove, in a manner similar to that described hereinabove with reference to potential answer filtering in FIG. 3.

If question keywords are found in multiple potential answers, the question keyword containing potential answers are ranked in accordance with the number of question keywords found. The potential answer or answers having the highest ranking are retained and all other potential answers are discarded.

A conciseness/proximity score is now calculated for each potential answer. The conciseness/proximity score preferably is based on the average of the following three metrics:

1. Question keyword conciseness score as calculated by potential answer filtering functionality as described hereinabove with reference to FIG. 3;
2. Noun-classification word distance, which is the shortest distance, expressed in number of characters, between a classification word and a noun within the potential answer. If the potential answer does not belong to any of the classification words, this distance is defined to be zero.
For example, if the question was “HOW FAR IS MARS FROM EARTH” the classification would be LENGTH. If the answer was “MARS IS 35 MILLION MILES AWAY FROM EARTH” then this score would be the distance between the word “Mars” and the length measurement “miles”, which is a distance of 19 characters.
3. Average proximity to the beginning of each potential answer of the first occurrence of each question keyword. To calculate this, the position of the first occurrence of each different question keyword is summed and divided by the number of different question keywords.
In the example brought above, the distance of each question keyword from the beginning of the potential answer is shown in parentheses, and the average proximity is indicated.
2—The soil on the Red(17) Planet is red because much of the soil contains iron oxide (rust). Average proximity=17/1=17.
In this example, the conciseness/proximity score of each of the potential answers is:

2−(2.5+0+17)/3=6.5

If the conciseness/proximity score of a potential answer is greater than a predetermined number, preferably 80, the potential answer is discarded.

The remaining potential answers are preferably stitched together to form a potential answer document. The potential answer document undergoes theme extraction, providing a list of potential answer words ranked by their frequency of occurrence in the potential answer document.

In conceptual terms, theme extraction utilizes statistical analysis of the frequency of occurrence of words in the potential answer document to identify at least one theme word of the potential answer document.

Potential answer theme extraction preferably includes the following steps:

Step 1—All non-alphanumeric characters are removed from the potential answer document, preferably by replacing matches of the following regular expression with spaces:

[symbol]

Step 2—The resulting document is then rendered into a list of potential answer words.

Step 3—The following words are then removed from the list of words:
Stopwords—Examples are: “the”, “and” & “but”
Common words, which appear very often in the English language. These words are ignored since they probably have little significance to the overall document. Examples are: “because”, “teach”, “take”, “speak”, “simply” & “select”.
Words less than three characters in length.

Preferably numbers are not removed.

Step 4—The remaining potential answer words in the list are stemmed to their roots, preferably using known stemming algorithms, such as the well-known Porter-stemming algorithm.

Step 5—An occurrence frequency score is generated for every different potential answer word in the list indicating the occurrence of the potential answer word in the potential answer document.

Step 6—Using the occurrence frequency score and knowing the number of different potential answer words in the potential answer document, an average potential answer word occurrence frequency is calculated for the potential answer document. Alternatively a median potential answer word occurrence frequency may be provided.

Preferably, all potential answer words having occurrence frequencies which are less than two times the average potential answer word occurrence frequency are discarded

A second average potential answer word occurrence frequency is calculated for the remaining potential answer words. Potential answer words having occurrence frequencies that are equal to or greater than the second average potential answer word occurrence frequency are defined to be “Potential Answer Theme Words”.

The Potential Answer Theme Words are then arranged in the order of their occurrence frequencies in a list, termed a Potential Answer Theme Word List.

Potential answers which do not contain Potential Answer Theme Words are discarded. The remaining potential answers are considered to be “best answers” and are ordered in accordance with increasing length, such that the most concise answers are presented first.

If no Potential Answer Theme Words are found, the remaining potential answers are ordered in accordance with their conciseness/proximity score.

The potential answers are preferably presented to the user, where the potential answers having the lowest conciseness/proximity score are presented first.

Preferably all Potential Answer Theme Words are stored in the Previous Answer Database (FIG. 2) for future use, thus enhancing future operation. Previously asked questions which contain Potential Answer Theme Words may be so classified in the Previous Answer Database.

In accordance with an alternative embodiment of the invention, prior to downloading all of the documents found in the Document. Retrieval Web Search stage (FIG. 2), only summaries of the documents are downloaded from the search engine server 120 (FIG. 1). These summaries are preferably stitched into a Document Summary Document and theme extraction (FIG. 3) is performed thereon to obtain Summary Theme Words. The document summaries found in the Document Retrieval Web Search are then examined to determine whether they contain the Summary Theme Words. Only documents whose summaries contain at least one Summary Theme Word are downloaded and processed by the answer extraction and answer ranking functionalities (FIG. 2).

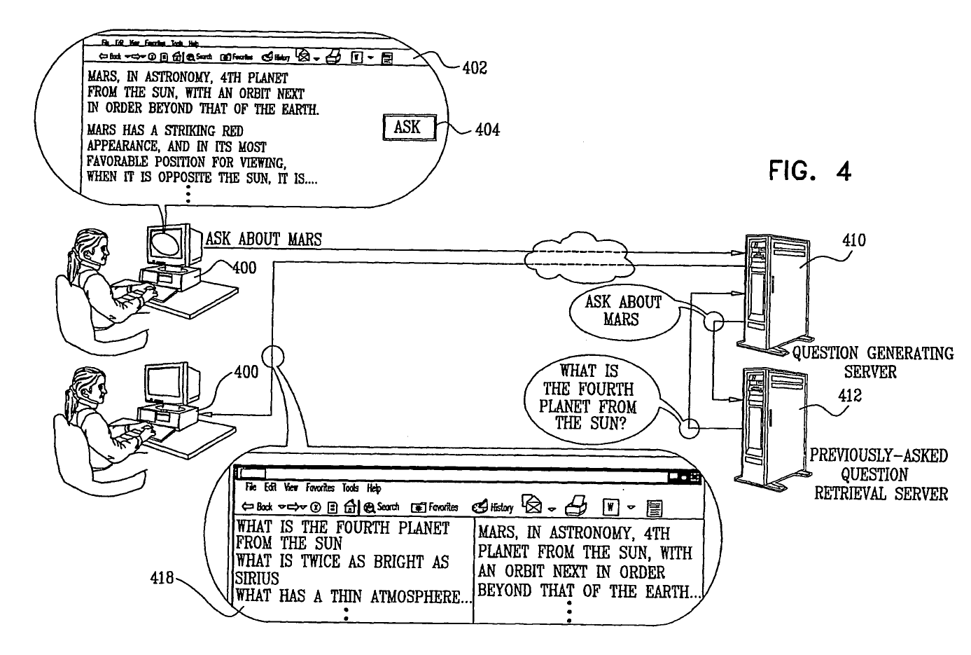

Reference is now made to FIG. 4, which is a simplified illustration of a typical question generating functionality operative in accordance with a preferred embodiment of the present invention. As seen in FIG. 4, a user, operating a client computer 400, employs a conventional web browser, such as Microsoft® Internet Explorer®, to access a web page 402 containing a text, and preferably containing a button 404 which enables question generation. The user presses the button 404 in order to generate at least one question which is related to the subject of the document displayed by the browser.

Alternatively, any other suitable methodology may be employed for entering a question generation command, such as the use of a voice responsive input device, a screen scraping functionality, an email functionality, an SMS functionality or an instant messaging functionality.

The request for question generation regarding the subject, including the web page 402, is supplied, typically via the Internet, to a question-generating server 410. Server 410 then utilizes theme extraction functionality in order to identify theme words present in the web page 402, and then supplies the theme words to a previously-asked question retrieval server 412.

Previously-asked question retrieval server 412 provides an output of previously-asked questions which contain the theme words, or having previously generated answers which contain the theme words, to question generating server 410.

The retrieved questions may be combined and presented to the user in any suitable format, such as in a text box 418 which is displayed by computer 400 adjacent web page 402.

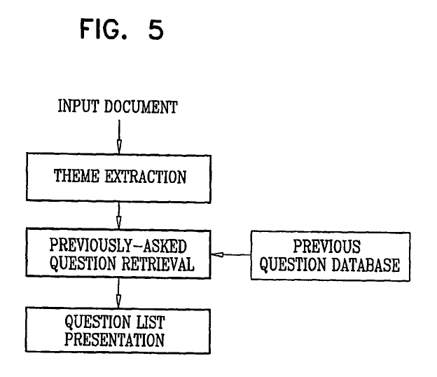

Reference is now made to FIG. 5, which is a simplified flow chart of the question generating functionality of FIG. 4. As seen in FIG. 5, an input document, such as web page 402 (FIG. 4), which is typically supplied by a user via computer 400 (FIG. 4), undergoes theme extraction by a theme extraction functionality of question generating server 410 (FIG. 4).

Theme extraction performed by the theme extraction functionality provides providing a list of words ranked by their frequency of occurrence in the input document.

In conceptual terms, theme extraction utilizes statistical analysis of the frequency of occurrence of words in the input document to identify at least one theme word of the input document. Theme extraction enables the generation of questions related to the main topics of the document, and not to side aspects of the document.

Theme extraction preferably includes the following steps:

Step 1—All non-alphanumeric characters are removed from the modified text document, preferably by replacing matches of the following regular expression with spaces:

[symbol]

Step 2—The resulting document is then rendered into a list of words.

Step 3—The following words are then removed from the list of words:
Stopwords—Examples are: “the”, “and” & “but”
Common words, which appear very often in the English language. These words are ignored since they probably have little significance to the overall document. Examples are: “because”, “teach”, “take”, “speal”, “simply” & “select”.
Words less than three characters in length.

Preferably numbers are not removed.

Step 4—The remaining words in the list are stemmed to their roots, preferably using known stemming algorithms, such as the well-known Porter-stemming algorithm.

Step 5—An occurrence frequency score is generated for every different word in the list indicating the occurrence of the word in the document.

Step 6—Using the occurrence frequency score and knowing the number of different words in the input document, an average word occurrence frequency is calculated for the document. Alternatively a median word occurrence frequency may be provided.

For example, if the initial document contains the following text:

“Mars, in astronomy, 4th planet from the sun, with an orbit next in order beyond that of the earth. Mars has a striking red appearance, and in its most favorable position for viewing, when it is opposite the sun, it is twice as bright as sirius, the brightest star. Mars has a diameter of 4,200 mi (6,800 km), just over half the diameter of the earth, and its mass is only 11% of the earth's mass. The planet has a very thin atmosphere consisting mainly of carbon dioxide, with some nitrogen and argon. Mars has an extreme day-to-night temperature range, resulting from its thin atmosphere, from about 80° F. (27° C.) at noon to about −100° F. (−73° C.) at midnight; however, the high daytime temperatures are confined to less than 3 ft (1 m) above the surface.”

Following step 3 above, the list of words contains the following words:

“Mars”, “astronomy”, “4^{th}”, “planet”, “sun”, “orbit”, “order”, “beyond”, “earth”, “Mars”, “striking”, “red”, “appearance”, “favorable”, “position”, “viewing”, “opposite”, “sun”, “twice”, “bright”, “Sirius”, “brightest”, “star”, “Mars”, “diameter” “4,200”, “6,800”, “half”, “diameter”, “earth”, “mass”, “earths”, “mass”, “planet”, “thin”, “atmosphere”, “consisting”, “mainly”, “carbon”, “dioxide”, “nitrogen”, “argon”, “Mars”, “extreme”, “temperature”, “range”, “resulting”, “thin”, “atmosphere”, “noon”, “100”, “midnight”, “daytime”, “temperatures”, “confined”, “surface”.

Following step 4 above, the list of words contains the following words:

“Mars”, “astronomy”, “4^{th}”, “planet”, “sun”, “orbit”, “order”, “beyond”, “earth”, “Mars”, “strike”, “red”, “appear”, “favor”, “position”, “view”, “opposite”, “sun”, “twice”, “bright”, “Sirius”, “bright”, “star”, “Mars”, “diameter” “4,200”, “6,800”, “half”, “diameter”, “earth”, “mass”, “earth”, “mass”, “planet”, “thin”, “atmosphere”, “consist”, “main”, “carbon”, “dioxide”, “nitrogen”, “argon”, “Mars”, “extreme”, “temperature”, “range”, “result”, “thin”, “atmosphere”, “noon”, “100”, “midnight”, “daytime”, “temperature”, “confine”, “surface”.

Following step 5 above, the occurrence frequency score for each of the words is:

“Mars”—4

“astronomy”—1

“planet”—2

“sun”—2

“orbit”—1

“order”—1

“beyond”—1

“earth”—3

“strike”—1

“red”—1

“appear”—1

“favor”—1

“position”—1

“view”—1

“opposite”—1

“twice”—1

“bright”—2

“Sirius”—1

“star”—1

“diameter”—2

“4,200”—1

“6,800”—1

“mass”—2

“thin”—2

“atmosphere”—2

“consist”—1

“main”—1

“carbon”—1

“dioxide”—1

“nitrogen”—1

“argon”—1

“extreme”—1

“temperature”—2

“range”—1

“result”—1

“noon”—1

“100”—1

“midnight”—1

“daytime”—1

“confine”—1

“surface”—1

The average word occurrence frequency is 1.3023

Preferably, all words having occurrence frequencies which are less than two times the average word occurrence frequency are discarded.

In the above example, the remaining list of words is:

“Mars”—4

“earth”—3

A second average word occurrence frequency is calculated for the remaining words. Words having occurrence frequencies that are equal to or greater than the second average word occurrence frequency are defined to be “Theme Words”.
The Theme Words are then arranged in the order of their occurrence frequencies in a list, termed a Theme Word List.

In the above example, the second average word occurrence frequency is (4+3)/2=3.5 and therefore the theme word list consists of: “Mars”.

Following theme extraction, a previously-asked question retrieval functionality supplies resulting theme words to a previous question database for retrieval of previously asked questions related to the theme words.

In accordance with a preferred embodiment of the present invention, the previously-asked question retrieval functionality compares the theme words to the questions and answers contained in the previously-asked questions database, and retrieves questions containing the theme words or having previously generated answers containing the theme words.

For the preceding example, the previously-asked question retrieval functionality may retrieve questions such as:

“What is the fourth planet from the sun?”

“What is twice as bright as Sirius?”

“What color is Mars?”

The retrieved questions are preferably presented to the user, preferably alongside the input document.

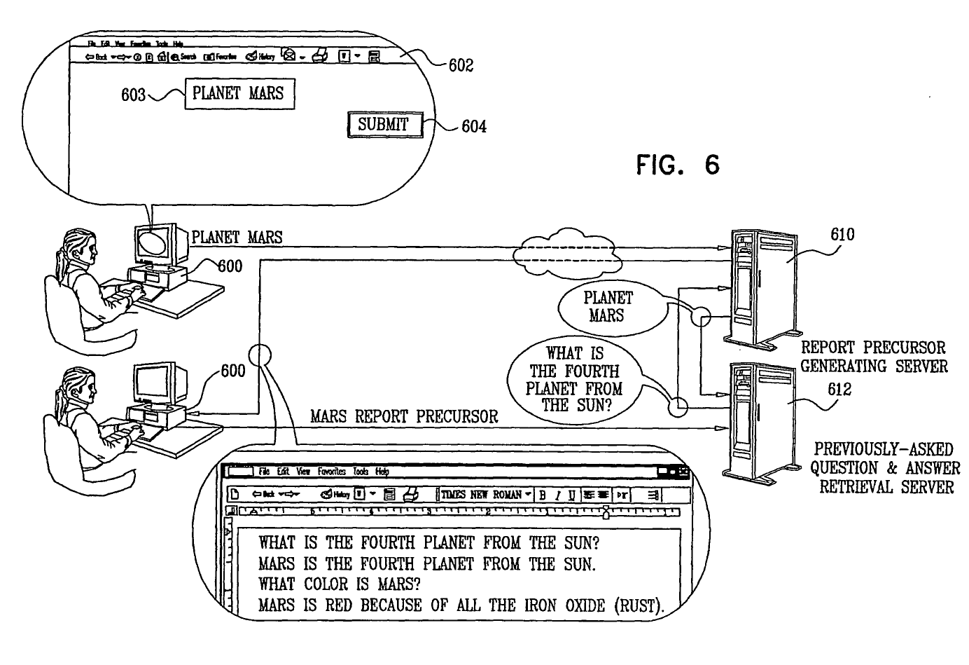

Reference is now made to FIG. 6, which is a simplified illustration of a typical report precursor generating methodology operative in accordance with a preferred embodiment of the present invention. As seen in FIG. 6, a user operating a client computer 600, employs a conventional web browser, such as Microsoft® Internet Explorer®, to access a web form page 602 containing a text box 603, and preferably containing a button 604 which enables report precursor generation.

The user preferably types a desired report topic words into text box 603, and then presses the button 604 in order to generate a report precursor which is related to the topic in text box 603.

Alternatively, any other suitable methodology may be employed for entering the report precursor topic, such as the use of a voice responsive input device, a screen scraping functionality, an email functionality, an SMS functionality or an instant messaging functionality.

The request for report precursor generation regarding the topic typed into text box 603, is supplied, typically via the Internet, to a report precursor-generating server 610. Server 610 supplies the desired report topic words to a previously-asked question and answer retrieval server 612.

Previously-asked question and answer retrieval server 612 provides an output of previously-asked questions which contain the topic words and answers thereto, as well as previously asked questions having previously generated answers which contain the topic words and the generated answers, to question generating server 610.

Additionally or alternatively, server 610 may utilize the previously asked questions obtained from server 612 to search a corpus, such as the Internet, for answers to the question. Preferably, server 610 searches the corpus for answers by using the functionality described hereinabove with reference to FIGS. 1-3. The questions and answers generated in this manner are typically added to the retrieved questions and answers for generating an editable report precursor.

As a further alternative, server 610 may string the questions and answers retrieved from server 612 to form a document, which is then supplied to the question generation functionality of FIGS. 4 and 5. Server 610 may then utilize the functionality described hereinabove with reference to FIGS. 1-3 to find answers to questions generated by the methodology of FIGS. 4 and 5. The questions and answers generated in this manner are typically added to the retrieved questions and answers for generating an editable report precursor.

The retrieved questions and answers may be combined and presented to the user in any suitable format, such as in a single editable report precursor format.

Preferably, the user then edits the report precursor to form a report, by adding questions, answers to questions, or additional information into the report precursor.

In accordance with a preferred embodiment of the present invention, the editable report precursor and/or the final report are archived, and the contents thereof is used in generating and/or retrieving questions and answers for enhancing the processing of additional report precursors and the overall functionality of the previous question/answer retrieving functionality.

It will be appreciated by persons skilled in the art that the present invention is not limited by what has been particularly shown and described hereinabove. Rather the scope of the present invention includes combinations and subcombinations of various features of the present invention as well as modifications which would occur to persons reading the foregoing description and which are not in the prior art.

1. A document searching method comprising:
employing a computer to receive, from a user, a query including at least one search term;
employing computerized answer retrieving functionality to generate document search terms including at least one additional search term not present in said query, which said at least one additional search term was acquired, prior to receipt by said computer of said query from said user, by said computerized answer retrieving functionality in response to at least one query in the form of a question; and
operating computerized search engine functionality to access a set of documents in response to said query, based not only on at least one search term supplied by said user in said query, but also on said at least one additional search term provided by said computerized answer retrieving functionality.

2. A document searching method according to claim 1 and wherein said query is a question.

3. A document searching method according to claim 1 and wherein said query is not a question.

4. A document searching method according to claim 1 and wherein said employing computerized answer retrieving functionality provides said at least one additional search term by retrieving search terms, acquired other than in response to earlier questions, received by said computerized answer retrieving functionality prior to receipt of said query from said user.

5. A document searching method according to claim 1 and wherein said employing a computer comprises employing said computer to receive said query by at least one of:
typing said query;
using a voice responsive input device;
using a screen scraping functionality;
using an email functionality;
using an SMS functionality; and
using an instant messaging functionality.

6. A document searching method according to claim 1 and wherein said employing computerized answer retrieving functionality to generate document search terms comprises utilizing computerized query normalizing functionality for normalizing said query.

7. A document searching method according to claim 6 and wherein said normalizing said query is performed based at least in part on at least one of a plurality of query normalization rules.

8. A document searching method according to claim 1 and wherein said employing computerized answer retrieving functionality to generate document search terms comprises generating document search terms, including said at least one additional search term not present in said query by replacing at least one word in said query by at least one selected synonym thereof.

9. A document searching method according to claim 8 and wherein said replacing at least one word in said query by at least one selected synonym thereof comprises employing computerized synonym retrieving functionality to identify said at least one selected synonym at least partially by reference to at least one word in said query other than said at least one word which is replaced by said at least one selected synonym.

10. A document searching method according to claim 9 and wherein said employing computerized synonym retrieving functionality comprises identifying said at least one selected synonym by:
identifying a plurality of synonyms; and
selecting at least one of said plurality of synonyms for which there exists a phrase in a corpus which is relevant to said query.

11. A document searching method according to claim 10 and wherein said identifying said at least one selected synonym comprises:
searching said corpus for occurrences of at least one of said plurality of synonyms for which there exists a phrase in said corpus which is relevant to said query; and
designating at least one of said plurality of synonyms as a selected synonym in accordance with a number of occurrences in said corpus of a phrase including said at least one of said plurality of synonyms which is relevant to said query.

12. A document searching method according to claim 1 and also comprising utilizing computerized query processing functionality to process said query prior to said operating computerized search engine functionality, said utilizing computerized query processing functionality including:
utilizing said computerized query processing functionality to generate at least one expected answer to said query;
utilizing said computerized query processing functionality to generate at least one preliminary search engine query based on said at least one expected answer;
utilizing said computerized query processing functionality to concatenate said at least one preliminary search engine query with said at least one additional search term not present in said query, thereby to form a concatenated search engine query; and
providing said concatenated search engine query to said computerized search engine functionality.

13. A document searching method according to claim 1 and also comprising providing a representation of at least one document in said set of documents to said user.

14. A document searching method according to claim 13 and wherein said providing a representation comprises presenting at least one link to said at least one document.

15. A document searching method according to claim 1 and also comprising:
extracting at least one answer to said query from at least one document in said set of documents; and
providing said at least one answer to said user.

16. A document searching method according to claim 15 and wherein said extracting at least one answer comprises analyzing said at least one document by:
carrying out theme extraction on said at least one document, said theme extraction utilizing statistical analysis of frequency of occurrence of words to identify at least one theme word of said at least one document;
extracting sentences from said at least one document;
selecting at least one of said sentences as a potential answer;
scoring each of said at least one of said sentences selected as a potential answer; and
identifying said at least one of said sentences selected as a potential answer based at least partially on results of said scoring.

17. A document searching method according to claim 15 and wherein said extracting at least one answer comprises:
enhancing said at least one document by:
identifying capitalized phrases which appear in said at least one document;
identifying designated capitalized words belonging to said capitalized phrases; and
adding, to said at least one document, adjacent each occurrence of a designated capitalized word that does not appear in a capitalized phrase, said designated capitalized word that does appear alongside thereof elsewhere in said document in a capitalized phrase; and
carrying out analysis of said at least one document in order to identify at least one portion thereof as a potential answer.

18. A document searching method according to claim 15 and wherein said providing said at least one answer to said user comprises presenting said at least one answer in an editable report precursor format.

19. A document searching method according to claim 1 and wherein said employing computerized answer retrieving functionality comprises employing artificial intelligence.

20. A system for document searching comprising:
a computer operative to receive, from a user, a query including at least one search term;
computerized answer retrieving functionality operative to generate document search terms including at least one additional search term not present in said query, which said at least one additional search term was acquired, prior to receipt by said computer of said query from said user, by said computerized answer retrieving functionality in response to at least one query in the form of a question; and
computerized search engine functionality operative to access a set of documents in response to said query, based not only on said at least one search term but also on said at least one additional search term provided by said computerized answer retrieving functionality.

21. A system for document searching according to claim 20 and wherein said query is a question.

22. A system for document searching according to claim 20 and wherein said query is not a question.

23. A system for document searching according to claim 20 and wherein said computerized answer retrieving functionality is operative to provide said at least one additional search term, by retrieving search terms acquired other than in response to earlier questions, received by said computerized answer retrieving functionality prior to receipt of said query from said user.

24. A system for document searching according to claim 20 and wherein said computer is operative to receive said query from at least one of:
a keyboard;
a voice responsive input device;
a screen scraping functionality;
an email functionality;
an SMS functionality; and
an instant messaging functionality.

25. A system for document searching according to claim 21 and wherein said computerized answer retrieving functionality includes computerized query normalizing functionality for normalizing said query.

26. A system for document searching according to claim 25 and wherein said computerized query normalizing functionality is operative to normalize said query based at least in part on at least one of a plurality of query normalization rules.

27. A system for document searching according to claim 20 and wherein said computerized answer retrieving functionality is operative to generate said at least one additional search term not present in said query by replacing at least one word in said query by at least one selected synonym thereof.

28. A system for document searching according to claim 27 and wherein said computerized answer retrieving functionality includes computerized synonym retrieving functionality operative to identify said at least one selected synonym at least partially by reference to at least one word in said query other than said at least one word which is replaced by said at least one selected synonym.

29. A system for document searching according to claim 28 and wherein said computerized synonym retrieving functionality includes a corpus and said computerized synonym retrieving functionality is operative to search said corpus for occurrences of at least one of a plurality of synonyms for which there exists a phrase relevant to said query and to designate at least one of said plurality of synonyms as a selected synonym in accordance with a number of occurrences in said corpus of a phrase including said at least one synonym which is relevant to said query.

30. A system for document searching according to claim 20 and also comprising a document output device for providing a representation of at least one document in said set of documents to said user.

31. A system for document searching according to claim 30 and wherein said document output device comprises a display for presenting at least one link to said at least one document.

32. A system for document searching according to claim 20 and also comprising:
computerized answer extraction functionality for extracting at least one answer from at least one document in said set of documents; and
an answer output device for providing said at least one answer to said user.

33. A system for document searching according to claim 32 and wherein said computerized answer extraction functionality includes a document analyzer operative to analyze said at least one document, said document analyzer including:
computerized theme extraction functionality for carrying out theme extraction on said at least one document, said theme extraction utilizing statistical analysis of frequency of occurrence of words to identify at least one theme word of said at least one document;
computerized sentence extracting functionality for extracting sentences from said at least one document;
a potential answer selector for selecting at least one of said sentences as a potential answer;
computerized scoring functionality for scoring each of said at least one of said sentences; and
a sentence identifier for identifying at least one of said sentences selected as a potential answer based at least partially on results of said scoring.

34. A system for document searching according to claim 32 and wherein said answer output device comprises a display for presenting said at least one answer to said user in an editable report precursor format.

35. A system for document searching according to claim 20 and wherein said computerized answer retrieving functionality includes artificial intelligence.

36. An answer extraction method comprising:
employing a computer to receive a question from a user;
employing a computer network to access a set of documents relevant to said question by employing document search terms derived by said computer from said question, said document search terms including at least one additional search term not present in the question, which said at least one additional search term was acquired prior to receipt of said question from said user;
analyzing said set of documents to extract at least one answer to said question; and
providing said at least one answer to said user.

37. An answer extraction method according to claim 36 and wherein said employing a computer network includes providing said at least one additional search term, by retrieving search terms acquired in response to earlier questions, received prior to receipt of said question from said user.

38. An answer extraction method according to claim 36 and wherein said employing a computer network includes providing said at least one additional search term by retrieving search terms, acquired other than in response to earlier questions, received prior to receipt of said question from said user.

39. An answer extraction method according to claim 36 and wherein said employing a computer network employs artificial intelligence.

40. An answer extraction method according to claim 36 and wherein said employing a computer to receive a question comprises employing said computer to receive said question by at least one of:
typing said question;
using a voice responsive input device;
using a screen scraping functionality;
using an email functionality;
using an SMS functionality; and
using an instant messaging functionality.

41. An answer extraction method according to claim 36 and wherein said employing document search terms comprises utilizing computerized question normalizing functionality for normalizing said question.

42. An answer extraction method according to claim 41 and wherein said normalizing said question is performed based at least in part on at least one of a plurality of question normalization rules.

43. An answer extraction method according to claim 36 and wherein said employing document search terms comprises generating document search terms including said at least one additional search term not present in said question by replacing at least one word in said question by at least one selected synonym thereof.

44. An answer extraction method according to claim 43 and wherein said replacing at least one word in said question by at least one selected synonym thereof comprises employing computerized synonym retrieving functionality to identify said at least one selected synonym at least partially by reference to at least one word in said question other than said at least one word which is replaced by said at least one selected synonym.

45. An answer extraction method according to claim 44 and wherein said employing computerized synonym retrieving functionality comprises identifying said at least one selected synonym by:
identifying a plurality of synonyms; and
selecting at least one of said plurality of synonyms for which there exists a phrase relevant to said question in a corpus.

46. An answer extraction method according to claim 45 and wherein said identifying said at least one selected synonym comprises:
searching said corpus for occurrences of at least one of said plurality of synonyms for which there exists a phrase relevant to said question; and
designating at least one synonym of said plurality of synonyms as a selected synonym in accordance with a number of occurrences in said corpus of a phrase including said at least one synonym which is relevant to said question.

47. An answer extraction method according to claim 36 and also comprising utilizing computerized question processing functionality to process said question, said utilizing computerized question processing functionality including:
utilizing said computerized question processing functionality to generate at least one expected answer to said question;
utilizing said computerized question processing functionality to generate at least one preliminary search engine query based on said at least one expected answer;
utilizing said computerized question processing functionality to concatenate said at least one preliminary search engine query with said at least one additional search term not present in said question, thereby to form a concatenated search engine query; and
deriving said document search terms from said concatenated search engine query.

48. An answer extraction method according to claim 36 and wherein said providing said at least one answer to said user also comprises providing a representation of at least one document of said set of documents to said user.

49. An answer extraction method according to claim 48 and wherein said providing a representation comprises presenting at least one link to said at least one document.

50. An answer extraction method according to claim 36 and wherein said analyzing said set of documents to extract at least one answer to said question comprises:
carrying out theme extraction on plural ones of said set of documents, said theme extraction utilizing statistical analysis of frequency of occurrence of words to identify at least one theme word of said at least one document;
extracting sentences from said at least one document;
selecting at least one of said sentences as a potential answer;
scoring each of said at least one of said sentences; and
identifying at least one of said sentences selected as a potential answer based at least partially on results of said scoring.

51. An answer extraction method according to claim 36 and wherein said analyzing said set of documents to extract said at least one answer comprises:
enhancing said at least one document of said set of documents by:
identifying capitalized phrases which appear in said at least one document;
identifying designated capitalized words belonging to said capitalized phrases; and
adding, to said at least one document adjacent each occurrence of a designated capitalized word that does not appear in a capitalized phrase, said designated capitalized word that does appear alongside thereof elsewhere in said at least one document in a capitalized phrase; and
carrying out analysis of said at least one document in order to identify at least one portion thereof as a potential answer.

52. An answer extraction method according to claim 36 and wherein said providing said at least one answer to said user comprises presenting said at least one answer in an editable report precursor format.

53. An answer extraction method according to claim 36 and wherein said question is not phrased in question format.

54. An answer extraction system comprising:
a computer operative to receive a question from a user;
computerized answer extraction functionality operative to employ a computer network to access a set of documents relevant to said question by employing document search terms derived by said computer from said question, said document search terms including at least one additional search term not present in the question, which said at least one additional search term was acquired prior to receipt of said question from said user;
computerized answer analysis functionality for analyzing said set of documents to extract at least one answer to said question; and
an output device operative to provide said at least one answer to said user.

55. An answer extraction system according to claim 54 and wherein said computer network provides said at least one additional search term by retrieving search terms, acquired in response to earlier questions, received prior to receipt of said question from said user.

56. An answer extraction system according to claim 54 and wherein said computer network provides said at least one additional search term by retrieving search terms, acquired other than in response to earlier questions, received prior to receipt of said question from said user.

57. An answer extraction system according to claim 54 and wherein said computer network employs artificial intelligence.

58. An answer extraction system according to claim 54 and wherein said computer is operative to receive said question from at least one of:
a keyboard;
a voice responsive input device;
a screen scraping functionality;
an email functionality;
an SMS functionality; and
an instant messaging functionality.

59. An answer extraction system according to claim 54 and wherein said computerized answer extraction functionality includes computerized question normalizing functionality for normalizing said question.

60. An answer extraction system according to claim 59 and wherein said computerized question normalizing functionality is operative to normalize said question based at least in part on at least one of a plurality of question normalization rules.

61. An answer extraction system according to claim 54 and wherein said computerized answer extraction functionality is operative to generate said at least one additional search term not present in said question by replacing at least one word in said question by at least one selected synonym thereof.

62. An answer extraction system according to claim 61 and wherein said computerized answer extraction functionality includes computerized synonym retrieving functionality operative to identify said at least one selected synonym at least partially by reference to at least one word in said question other than said at least one word which is replaced by said at least one selected synonym.

63. An answer extraction system according to claim 62 and wherein said computerized synonym retrieving functionality includes a corpus and said computerized synonym retrieving functionality is operative to search said corpus for occurrences of each one of a plurality of synonyms for which there exists a phrase including said one of said plurality of synonyms relevant to said question, and to designate at least one of said plurality of synonyms as a selected synonym in accordance with a number of occurrences in said corpus of a phrase including said at least one of said plurality of synonyms relevant to said question.

64. An answer extraction system according to claim 54 and wherein said output device is operative to provide a representation of at least one document of said set of documents to said user.

65. An answer extraction system according to claim 64 and wherein said output device comprises a display for presenting at least one link to said at least one document to said user.

66. An answer extraction system according to claim 54 and wherein said computerized answer extraction functionality includes:
computerized theme extraction functionality for carrying out theme extraction on plural ones of said set of documents, said theme extraction utilizing statistical analysis of frequency of occurrence of words to identify at least one theme word of said at least one document;
computerized sentence extracting functionality for extracting sentences from said at least one document;
a potential answer selector for selecting at least one of said sentences as a potential answer;
scoring functionality for scoring each said at least one of said sentences; and
a sentence identifier for identifying at least one of said sentences selected as a potential answer based at least partially on results of said scoring.

67. An answer extraction system according to claim 54 and wherein said output device comprises a display for presenting said at least one answer in an editable report precursor format.

68. An answer extraction system according to claim 54 and wherein said question is not phrased in question format.

69. An answer extraction method comprising:
employing a computer to receive a question from a user;
employing a computer network to access a set of documents relevant to said question by employing document search terms derived by said computer from said question;
extracting at least one answer to said question; and
providing said at least one answer to said user,
said extracting at least one answer comprising:
generating an expected answer to said question, said expected answer including question keywords;
analyzing said set of documents by:
carrying out theme extraction on plural ones of said set of documents, said theme extraction utilizing statistical analysis of the frequency of occurrence of words to identify at least one theme word of a document, which theme word may or may not be a question keyword; and
extracting sentences from plural ones of said set of documents;
selecting at least one of said sentences as a potential answer if it fulfills at least one of the following criteria:
a sentence including at least a predetermined plurality of question keywords; and
a sentence including at least one question keyword and at least one theme word;
scoring each of said at least one of said sentences selected as a potential answer; and
identifying at least one of said at least one of said sentences selected as a potential answer based at least partially on results of said scoring.

70. An answer extraction method according to claim 69 and wherein said employing a computer to receive a question comprises employing said computer to receive said question by at least one of:
typing said question;
using a voice responsive input device;
using a screen scraping functionality;
using an email functionality;
using an SMS functionality; and
using an instant messaging functionality.

71. An answer extraction method according to claim 69 and also comprising, prior to said employing a computer network to access a set of documents:
utilizing computerized question normalization functionality for normalizing said question; and
thereafter, utilizing computerized question classification functionality to classify said question.

72. An answer extraction method according to claim 71 and wherein said normalizing said question is performed based at least in part on at least one of a plurality of question normalization rules.

73. An answer extraction method according to claim 69 and wherein said employing a computer network comprises employing said computer to derive said document search terms including at least one additional search term not present in the question, which said at least one additional search term was acquired prior to receipt of said question from said user.

74. An answer extraction method according to claim 69 and wherein said employing a computer network comprises employing said computer to derive said document search terms including at least one additional search term not present in the question by replacing at least one word in said question by at least one selected synonym thereof.

75. An answer extraction method according to claim 74 and wherein said replacing at least one word in said question by at least one selected synonym thereof comprises employing computerized synonym retrieving functionality to identify said at least one selected synonym at least partially by reference to at least one word in said question other than said at least one word which is replaced by said at least one selected synonym.

76. An answer extraction method according to claim 75 and wherein said employing computerized synonym retrieving functionality comprises identifying said at least one selected synonym by:
identifying a plurality of synonyms; and
selecting at least one of said plurality of synonyms for which there exists a phrase relevant to said question in a corpus.

77. An answer extraction method according to claim 76 and wherein said identifying said at least one selected synonym comprises:
searching said corpus for occurrences of at least one of said plurality of synonyms for which there exists a phrase relevant to said question; and
designating at least one of said plurality of synonyms as a selected synonym in accordance with a number of occurrences in said corpus of a phrase including said at least one of said plurality of synonyms which is relevant to said question.

78. An answer extraction method according to claim 69 and also comprising providing a representation of said at least one document of said set of documents to said user.

79. An answer extraction method according to claim 78 and wherein said providing a representation comprises presenting at least one link to said at least one document.

80. An answer extraction method according to claim 69 and wherein said providing said at least one answer to said user comprises presenting said at least one answer in an editable report precursor format.

81. An answer extraction method according to claim 69 and wherein said statistical analysis comprises:
for each word in said document, stemming said word to a corresponding root word;
generating a word occurrence frequency score for each different root word corresponding to a word in said document;
using said word occurrence frequency scores to calculate a document word occurrence frequency indicating score for said document;
selecting a subset of words in said document including at least one word having a word occurrence frequency score which is greater than or equal to said document word occurrence frequency indicating score.

82. An answer extraction method according to claim 81 and wherein said document word occurrence frequency indicating score comprises at least one of an average of said word occurrence frequency scores and a median of said word occurrence frequency scores.

83. An answer extraction method according to claim 81 and wherein said statistical analysis comprises selecting, as said at least one theme word, at least one word having a word occurrence frequency score which is greater than or equal to twice said document word occurrence frequency indicating score.

84. An answer extraction method according to claim 81 and wherein said statistical analysis also comprises:
following said selecting a subset of words in said document, calculating a subset word occurrence frequency indicating score; and
selecting, as said at least one theme word, at least one of said subset of words having a word occurrence frequency score which is greater than or equal to said subset word occurrence frequency indicating score.

85. An answer extraction method according to claim 84 and wherein said subset word occurrence frequency indicating score comprises at least one of an average of said word occurrence frequency scores of words in said subset of words and a median of said word occurrence frequency scores of words in said subset of words.

86. An answer extraction method according to claim 69 and wherein said question is not phrased in question format.

87. An answer extraction system comprising:
a computer operative to receive a question from a user; and
computerized answer extraction functionality operative to employ a computer network to access a set of documents relevant to said question by employing document search terms derived by said computer from said question, to extract at least one answer to said question and to provide said at least one answer to said user,
said computerized answer extraction functionality comprising:
an expected answer generator operative to generate an expected answer to said question, said expected answer including question keywords;
a document analyzer operative to carry out theme extraction on plural ones of said set of documents, said theme extraction utilizing statistical analysis of the frequency of occurrence of words in a document to identify at least one theme word of said document, which theme word may or may not be a question keyword;
a sentence extractor, operative to extract sentences from plural ones of said set of documents;
a potential answer selector, operative to select at least one of said sentences as a potential answer if it fulfills at least one of the following criteria:
a sentence including at least a predetermined plurality of question keywords; and
a sentence including at least one question keyword and at least one theme word; and
a potential answer identifier, operative to calculate a score for each of said at least one of said sentences selected as a potential answer and to identify at least one of said sentences selected as a potential answer based at least partially on said score.

88. An answer extraction system according to claim 87 and wherein said computer is operative to receive said question from at least one of:
a keyboard;
a voice responsive input device;
a screen scraping functionality;
an email functionality;
an SMS functionality; and
an instant messaging functionality.

89. An answer extraction system according to claim 87 and also comprising:
computerized question normalizing functionality operative to normalize said question; and
computerized question classification functionality for classifying said question.

90. An answer extraction system according to claim 89 and wherein said computerized question normalizing functionality is operative to normalize said question based at least in part on at least one of a plurality of question normalization rules.

91. An answer extraction system according to claim 87 and wherein said computerized answer extraction functionality is operative to employ said computer to derive said document search terms, including at least one additional search term not present in the question, which said at least one additional search term was acquired prior to receipt of said question from said user.

92. An answer extraction system according to claim 87 and wherein said computerized answer extraction functionality is operative to employ said computer to derive said document search terms, including at least one additional search term not present in the question, by replacing at least one word in said question by at least one selected synonym thereof.

93. An answer extraction system according to claim 92 and wherein said computerized answer extraction functionality includes computerized synonym retrieving functionality operative to identify said at least one selected synonym at least partially by reference to at least one word in said question other than said at least one word which is replaced by said at least one selected synonym.

94. An answer extraction system according to claim 93 and wherein said computerized synonym retrieving functionality includes a corpus and said computerized synonym retrieving functionality is operative to search said corpus for occurrences of at least one of a plurality of synonyms for which there exists a phrase relevant to said question and to designate at least one synonym as a selected synonym in accordance with a number of occurrences in said corpus of a phrase, including said at least one synonym which is relevant to said question.

95. An answer extraction system according to claim 87 and also comprising a document output device for providing a representation of at least one document of said set of documents to said user.

96. An answer extraction system according to claim 95 and wherein said document output device comprises a display for presenting at least one link to said at least one document.

97. An answer extraction system according to claim 87 and also comprising an answer output device for providing said at least one answer to said user.

98. An answer extraction system according to claim 97 and wherein said answer output device comprises a display for presenting said at least one answer in an editable report precursor format.

99. An answer extraction system according to claim 87 and wherein said document analyzer comprises:
computerized word stemming functionality, operative, for each word in said document, to stem said word to a corresponding root word;
a word occurrence frequency score generator for generating a word occurrence frequency score for each different root word corresponding to a word in said document;
computerized document word occurrence frequency indicating score calculating functionality operative to use said word occurrence frequency scores to calculate a document word occurrence frequency indicating score for said document; and
computerized word selecting functionality operative to select a subset of words in said document including at least one word having a word occurrence frequency score which is greater than or equal to said document word occurrence frequency indicating score.

100. An answer extraction system according to claim 99 and wherein said computerized document word occurrence frequency indicating score calculating functionality is operative to calculate said document word occurrence frequency indicating score by calculating at least one of an average of said word occurrence frequency scores and a median of said word occurrence frequency scores.

101. An answer extraction system according to claim 99 and wherein said computerized word selecting functionality is operative to select, as said at least one theme word, at least one word having a word occurrence frequency score which is greater than or equal to twice said document word occurrence frequency indicating score.

102. An answer extraction system according to claim 99 and wherein said document analyzer also comprises:
computerized subset word occurrence frequency indicating score calculating functionality, operative to calculate a subset word occurrence frequency indicating score; and
computerized theme word selection functionality operative to select, as said at least one theme word, at least one of said subset of words having a word occurrence frequency score which is greater than or equal to said subset word occurrence frequency indicating score.

103. An answer extraction system according to claim 102 and wherein said computerized subset word occurrence frequency indicating score calculating functionality is operative to calculate said subset word occurrence frequency indicating score by calculating at least one of an average of said word occurrence frequency scores of words in said subset of words and a median of said word occurrence frequency scores of words in said subset of words.

104. An answer extraction system according to claim 87 and wherein said question is not phrased in question format.

105. An answer extraction method comprising:
employing a computer to receive a question from a user;
employing a computer network to access a set of documents relevant to said question by employing document search terms derived by said computer from said question;
extracting at least one answer to said question; and
providing said at least one answer to said user,
said extracting at least one answer including:
enhancing at least one of said set of documents by:
identifying capitalized phrases which appear in said at least one document;
identifying designated capitalized words belonging to said capitalized phrases; and
adding, to said at least one document adjacent each occurrence of a designated capitalized word that does not appear in a capitalized phrase, the designated capitalized word that does appear alongside thereof elsewhere in the document in a capitalized phrase; and
carrying out analysis of said at least one document in order to identify at least one portion thereof as a potential answer.

106. An answer extraction method according to claim 105 and wherein said employing a computer to receive a question comprises employing said computer to receive said question by at least one of:
typing said question;
using a voice responsive input device;
using a screen scraping functionality;
using an email functionality;
using an SMS functionality; and
using an instant messaging functionality.

107. An answer extraction method according to claim 105 and also comprising, prior to said employing said computer network:
utilizing computerized question normalization functionality for normalizing said question; and
thereafter, utilizing computerized question classification functionality to classify said question.

108. An answer extraction method according to claim 107 and wherein said normalizing said question is performed based at least in part on at least one of a plurality of question normalization rules.

109. An answer extraction method according to claim 105 and wherein said employing a computer network comprises employing said computer to derive said document search terms, including at least one additional search term not present in the question, which said at least one additional search term was acquired prior to receipt of said question from said user.

110. An answer extraction method according to claim 105 and wherein said employing a computer network comprises employing said computer to derive said document search terms, including at least one additional search term not present in the question by replacing at least one word in said question by at least one selected synonym thereof.

111. An answer extraction method according to claim 110 and wherein said replacing at least one word in said question by at least one selected synonym thereof comprises employing computerized synonym retrieving functionality to identify said at least one selected synonym at least partially by reference to at least one word in said question other than said at least one word which is replaced by said at least one selected synonym.

112. An answer extraction method according to claim 111 and wherein said employing computerized synonym retrieving functionality comprises identifying said at least one selected synonym by:
identifying a plurality of synonyms; and
selecting at least one of said plurality of synonyms for which there exists a phrase relevant to said question in a corpus.

113. An answer extraction method according to claim 112 and wherein said identifying said at least one selected synonym comprises:
searching said corpus for occurrences of at least one of said plurality of synonyms for which there exists a phrase relevant to said question; and
designating at least one synonym as a selected synonym in accordance with a number of occurrences in said corpus of a phrase including said at least one synonym which is relevant to said question.

114. An answer extraction method according to claim 105 and wherein said extracting at least one answer also comprises, prior to said enhancing, generating an expected answer to said question, said expected answer including question keywords, and wherein said carrying out analysis of said at least one document comprises:
carrying out theme extraction on said at least one document, said theme extraction utilizing statistical analysis of the frequency of occurrence of words to identify at least one theme word of said at least one document, which theme word may or may not be a question keyword;
extracting sentences from said at least one document;
selecting at least one of said sentences as a potential answer if it fulfills at least one of the following criteria:
a sentence including at least a predetermined plurality of question keywords; and
a sentence including at least one question keyword and at least one theme word;
scoring each of said at least one of said sentences selected as a potential answer; and
identifying at least one of said sentences selected as a potential answer based at least partially on results of said scoring.

115. An answer extraction method according to claim 114 and wherein said statistical analysis comprises:
for each word in said at least one document, stemming said word to a corresponding root word;
generating a word occurrence frequency score for each different root word corresponding to a word in said at least one document;
using said word occurrence frequency scores to calculate a document word occurrence frequency indicating score for said at least one document; and
selecting as potential theme words a subset of words in said at least one document including at least one word having a word occurrence frequency score which is greater than or equal to said document word occurrence frequency indicating score.

116. An answer extraction method according to claim 115 and wherein said document word occurrence frequency indicating score comprises at least one of an average of said word occurrence frequency scores and a median of said word occurrence frequency scores.

117. An answer extraction method according to claim 115 and wherein said selecting as potential theme words comprises selecting, as said at least one theme word, at least one word having a word occurrence frequency score which greater than or equal to twice said document word occurrence frequency indicating score.

118. An answer extraction method according to claim 114 and wherein said statistical analysis also comprises:
following said selecting as potential theme words a subset of words in said at least one document, calculating a subset word occurrence frequency indicating score; and
selecting, as said at least one theme word, at least one of said subset of words having a word occurrence frequency score which is greater than or equal to said subset word occurrence frequency indicating score.

119. An answer extraction method according to claim 118 and wherein said subset word occurrence frequency indicating score comprises at least one of an average of said word occurrence frequency scores of words in said subset of words and a median of said word occurrence frequency scores of words in said subset of words.

120. An answer extraction method according to claim 105 and also comprising providing a representation of at least one of said set of documents to said user.

121. An answer extraction method according to claim 120 and wherein said providing a representation comprises presenting at least one link to said at least one document.

122. An answer extraction method according to claim 105 and wherein said providing said at least one answer to said user comprises presenting said at least one answer in an editable report precursor format.

123. An answer extraction method according to claim 105 and wherein said question is not phrased in question format.

124. An answer extraction system comprising:
a computer operative to receive a question from a user;
computerized answer extraction functionality operative to employ a computer network to access a set of documents relevant to said question by employing document search terms derived by said computer from said question, to extract at least one answer to said question and to provide said at least one answer to said user,
said computerized answer extraction functionality comprising a document analyzer operative to identify capitalized phrases which appear in a document belonging to said set of documents, to identify designated capitalized words belonging to said capitalized phrases, to add to said document adjacent each occurrence of a designated capitalized word that does not appear in a capitalized phrase, the designated capitalized word that does appear alongside thereof elsewhere in said document in a capitalized phrase, thereby providing an enhanced document, and to carry out analysis of said enhanced document in order to identify at least one portion thereof as a potential answer.

125. An answer extraction system according to claim 124 and wherein said computer is operative to receive said question from at least one of:
a keyboard;
a voice responsive input device;
a screen scraping functionality;
an email functionality;
an SMS functionality; and
an instant messaging functionality.

126. An answer extraction system according to claim 124 and also comprising:
computerized question normalizing functionality operative for normalizing said question; and
computerized question classification functionality for classifying said question.

127. An answer extraction system according to claim 126 and wherein said computerized question normalizing functionality is operative to normalize said question based at least in part on at least one of a plurality of question normalization rules.

128. An answer extraction system according to claim 124 and wherein said computerized answer extraction functionality is operative to employ said computer to derive said document search terms, including at least one additional search term not present in the question, which said at least one additional search term was acquired prior to receipt of said question from said user.

129. An answer extraction system according to claim 124 and wherein said computerized answer extraction functionality is operative to employ said computer to derive said document search terms, including at least one additional search term not present in the question by replacing at least one word in said question by at least one selected synonym thereof.

130. An answer extraction system according to claim 129 and wherein said computerized answer extraction functionality includes computerized synonym retrieving functionality operative to identify said at least one selected synonym at least partially by reference to at least one word in said question other than said at least one word which is replaced by said at least one selected synonym.

131. An answer extraction system according to claim 130 and wherein said computerized synonym retrieving functionality includes a corpus and said computerized synonym retrieving functionality is operative to search said corpus for occurrences of at least one of a plurality of synonyms for which there exists a phrase relevant to said question and to designate at least one of said plurality of synonyms as a selected synonym in accordance with a number of occurrences in said corpus of a phrase including said at least one of said plurality of synonyms which is relevant to said question.

132. An answer extraction system according to claim 124 and wherein said computerized answer extraction functionality also comprises an expected answer generator operative to generate an expected answer to said question, said expected answer including question keywords, and wherein said document analyzer comprises:
computerized theme extraction functionality for carrying out theme extraction on said document, said theme extraction utilizing statistical analysis of the frequency of occurrence of words to identify at least one theme word of said document, which theme word may or may not be a question keyword;
a sentence extractor, operative to extract sentences from said document;
a potential answer selector, operative to select at least one of said sentences as a potential answer if it fulfills at least one of the following criteria:
a sentence including at least a predetermined plurality of question keywords; and
a sentence including at least one question keyword and at least one theme word; and
a potential answer identifier, operative to calculate a score for each of said at least one of said sentences and to identify at least one of said sentences selected as a potential answer based at least partially on results of said score.

133. An answer extraction system according to claim 132 and wherein said document analyzer comprises:
computerized word stemming functionality, operative, for each word in said document, to stem said word to a corresponding root word;
a word occurrence frequency score generator for generating a word occurrence frequency score for each different root word corresponding to a word in said document;
computerized document word occurrence frequency indicating score calculating functionality operative to use said word occurrence frequency scores to calculate a document word occurrence frequency indicating score for said document; and
computerized word selecting functionality operative to select a subset of words in said document including at least one word having a word occurrence frequency score which is greater than or equal to said document word occurrence frequency indicating score.

134. An answer extraction system according to claim 133 and wherein said computerized document word occurrence frequency indicating score calculating functionality is operative to calculate said document word occurrence frequency indicating score by calculating at least one of an average of said word occurrence frequency scores and a median of said word occurrence frequency scores.

135. An answer extraction system according to claim 132 and wherein said computerized theme extraction functionality is operative to select, as said at least one theme word, at least one word having a word occurrence frequency score which is greater than or equal to twice said document word occurrence frequency indicating score.

136. An answer extraction system according to claim 132 and wherein said document analyzer also comprises:
computerized subset word occurrence frequency indicating score calculating functionality, operative to calculate a subset word occurrence frequency indicating score; and
computerized theme word selection functionality operative to select, as said at least one theme word, at least one of said subset of words having a word occurrence frequency score which is greater than or equal to said subset word occurrence frequency indicating score.

137. An answer extraction system according to claim 136 and wherein said computerized subset word occurrence frequency indicating score calculating functionality is operative to calculate said subset word occurrence frequency indicating score by calculating at least one of an average of said word occurrence frequency scores of words in said subset of words and a median of said word occurrence frequency scores of words in said subset of words.

138. An answer extraction system according to claim 124 and also comprising a document output device for providing a representation of at least one of said set of documents to said user.

139. An answer extraction system according to claim 138 and wherein said document output device comprises a display for presenting at least one link to said at least one document.

140. An answer extraction system according to claim 124 and also comprising an answer output device for providing said at least one answer to said user.

141. An answer extraction system according to claim 140 and wherein said answer output device comprises a display for presenting said at least one answer in an editable report precursor format.

142. An answer extraction system according to claim 124 and wherein said question is not phrased in question format.

143. An answer extraction method comprising:
employing a computer to receive a question from a user;
employing a computer network to access a set of documents relevant to said question by employing document search terms derived by said computer from said question;
extracting at least one answer to said question; and
providing said at least one answer to said user,
said extracting at least one answer to said question comprising:
identifying a multiplicity of potential answers; and
evaluating each of said multiplicity of potential answers according to at least one of the following criteria:
proximity of question keywords in the potential answer;
proximity of classification words and nouns in the potential answer; and
word count of at least part of the potential answer.

144. An answer extraction method according to claim 143 and wherein said evaluating comprises evaluating each of said multiplicity of potential answers according to at least two of the following criteria:
proximity of question keywords in the potential answer;
proximity of classification words and nouns in the potential answer; and
word count of at least part of the potential answer.

145. An answer extraction method according to claim 143 and wherein said evaluating comprises evaluating each of said multiplicity of potential answers according to all of the following criteria:
proximity of question keywords in the potential answer;
proximity of classification words and nouns in the potential answer; and
word count of at least part of the potential answer.

146. An answer extraction method according to claim 143 and wherein said evaluating comprises evaluating each of said multiplicity of potential answers according to a combination of the following criteria:
proximity of question keywords in the potential answer;
proximity of classification words and nouns in the potential answer; and
word count of at least part of the potential answer.

147. An answer extraction method according to claim 143 and wherein said extracting at least one answer also comprises selecting a sub group of said multiplicity of potential answers based on an evaluation of said multiplicity of potential answers in accordance with said criteria.

148. An answer extraction method according to claim 147 and wherein said evaluation comprises scoring said multiplicity of potential answers in accordance with said criteria.

149. An answer extraction method according to claim 148 and also comprising:
forming a potential answer document by combining said multiplicity of potential answers;
extracting a theme of said sub group of said multiplicity of potential answers, by utilizing statistical analysis of the frequency of occurrence of words in said potential answer document to identify at least one theme word in said sub group of said multiplicity of potential answers, which theme word may or may not be a question keyword; and
discarding potential answers belonging to said sub group of said multiplicity of potential answers which do not include at least one of said at least one theme word.

150. An answer extraction method according to claim 149 and wherein said statistical analysis comprises:
for each word in said potential answer document, stemming said word to a corresponding root word;
generating a word occurrence frequency score for each different root word corresponding to a word in said potential answer document;
using said word occurrence frequency scores to calculate a document word occurrence frequency indicating score for said potential answer document; and
selecting a subset of words in said potential answer document including at least one word having a word occurrence frequency score which is greater than or equal to said document word occurrence frequency indicating score.

151. An answer extraction method according to claim 150 and wherein said document word occurrence frequency indicating score comprises at least one of an average of said word occurrence frequency scores and a median of said word occurrence frequency scores.

152. An answer extraction method according to claim 149 and wherein said extracting a theme comprises selecting, as said at least one theme word, at least one word having a word occurrence frequency score which is greater than or equal to twice said document word occurrence frequency indicating score.

153. An answer extraction method according to claim 149 and wherein said statistical analysis also comprises, following said selecting a subset of words in said potential answer document:
calculating a subset word occurrence frequency indicating score; and
selecting as said at least one theme word, at least one of said subset of words having a word occurrence frequency score which is greater than or equal to said subset word occurrence frequency indicating score.

154. An answer extraction method according to claim 153 and wherein said subset word occurrence frequency indicating score comprises at least one of an average of said word occurrence frequency scores of words in said subset of words and a median of said word occurrence frequency scores of words in said subset of words.

155. An answer extraction method according to claim 143 and wherein said providing said at least one answer to said user comprises providing said at least one answer to said user in an order governed at least in part by at least one of:
a word count of each of said at least one answer;
a score resulting from application to each of said at least one answer of at least one of the following criteria:
proximity of question keywords in said at least one answer;
proximity of classification words and nouns in said at least one answer; and
word count of at least part of said at least one answer.

156. An answer extraction method according to claim 143 and wherein said employing a computer to receive said question comprises employing said computer to receive said question by at least one of:
typing said question;
using a voice responsive input device;
using a screen scraping functionality;
using an email functionality;
using an SMS functionality; and
using an instant messaging functionality.

157. An answer extraction method according to claim 143 and also comprising, prior to said employing a computer network:
utilizing computerized question normalization functionality for normalizing said question; and
thereafter, utilizing computerized question classification functionality to classify said question.

158. An answer extraction method according to claim 157 and wherein said normalizing said question is performed based at least in part on at least one of a plurality of question normalization rules.

159. An answer extraction method according to claim 143 and wherein said employing a computer network comprises employing said computer to derive said document search terms, including at least one additional search term not present in the question, which said at least one additional search term was acquired prior to receipt of said question from said user.

160. An answer extraction method according to claim 143 and wherein said employing a computer network comprises employing said computer to derive said document search terms, including at least one additional search term not present in the question by replacing at least one word in said question by at least one selected synonym thereof.

161. An answer extraction method according to claim 160 and wherein said replacing at least one word in said question by at least one selected synonym thereof comprises employing computerized synonym retrieving functionality to identify said at least one selected synonym at least partially by reference to at least one word in said question other than said at least one word which is replaced by said at least one selected synonym.

162. An answer extraction method according to claim 161 and wherein said employing computerized synonym retrieving functionality comprises identifying said at least one selected synonym by:
identifying a plurality of synonyms; and
selecting at least one of said plurality of synonyms for which there exists a phrase relevant to said question in a corpus.

163. An answer extraction method according to claim 162 and wherein said identifying said at least one selected synonym comprises:
searching said corpus for occurrences of at least one of said plurality of synonyms for which there exists a phrase relevant to said question; and
designating at least one of said plurality of synonyms as a selected synonym in accordance with a number of occurrences in said corpus of a phrase including said at least one of said plurality of synonyms which is relevant to said question.

164. An answer extraction method according to claim 143 and wherein said identifying a multiplicity of potential answers also comprises:
enhancing at least one of said set of documents by:
identifying capitalized phrases which appear in said at least one of said set of documents;
identifying designated capitalized words belonging to said capitalized phrases; and
adding, to said at least one of said set of documents adjacent each occurrence of a designated capitalized word that does not appear in a capitalized phrase, the designated capitalized word that does appear alongside thereof elsewhere in the document in a capitalized phrase; and
carrying out analysis of said at least one of said set of documents in order to identify at least one portion thereof as a potential answer.

165. An answer extraction method according to claim 164 and wherein said identifying a multiplicity of potential answers also comprises, prior to said enhancing, generating an expected answer to said question, said expected answer including question keywords, and wherein said carrying out analysis comprises:
carrying out theme extraction on said at least one of said set of documents, said theme extraction utilizing statistical analysis of the frequency of occurrence of words to identify at least one theme word of said at least one of said set of documents, which theme word may or may not be a question keyword;
extracting sentences from said at least one of said set of documents;
selecting at least one of said sentences as a potential answer if it fulfills at least one of the following criteria:
a sentence including at least a predetermined plurality of question keywords; and
a sentence including at least one question keyword and at least one theme word;
scoring each of said at least one of said sentences selected as a potential answer; and
identifying at least one of said sentences selected as a potential answer based at least partially on results of said scoring.

166. An answer extraction method according to claim 143 and also comprising providing a representation of at least one of said set of documents to said user.

167. An answer extraction method according to claim 166 and wherein said providing a representation comprises presenting at least one link to said at least one of said set of documents.

168. An answer extraction method according to claim 143 and wherein said providing said at least one answer to said user comprises presenting said at least one answer in an editable report precursor format.

169. An answer extraction method according to claim 143 and wherein said question is not phrased in question format.

170. An answer extraction system comprising:
a computer operative to receive a question from a user;
computerized answer extraction functionality operative to employ a computer network to access a set of documents relevant to said question by employing document search terms derived by said computer from said question, to extract at least one answer to said question and to provide said at least one answer to said user, said computerized answer extraction functionality being operative to identify a multiplicity of potential answers and to evaluate each of said multiplicity of potential answers according to at least one of the following criteria:
proximity of question keywords in the potential answer;
proximity of classification words and nouns in the potential answer; and
word count of at least part of the potential answer.

171. An answer extraction system according to claim 170 and wherein said computerized answer extraction functionality is operative to evaluate each of said multiplicity of potential answers according to at least two of the following criteria:
proximity of question keywords in the potential answer;
proximity of classification words and nouns in the potential answer; and
word count of at least part of the potential answer.

172. An answer extraction system according to claim 171 and wherein said computerized answer extraction functionality is operative to evaluate each of said multiplicity of potential answers according to all of the following criteria:
proximity of question keywords in the potential answer;
proximity of classification words and nouns in the potential answer; and
word count of at least part of the potential answer.

173. An answer extraction system according to claim 172 and wherein said computerized answer extraction functionality is operative to evaluate each of said multiplicity of potential answers according to a combination of the following criteria:
proximity of question keywords in the potential answer;
proximity of classification words and nouns in the potential answer; and
word count of at least part of the potential answer.

174. An answer extraction system according to claim 170 and wherein said computerized answer extraction functionality is also operative to select a sub group of said multiplicity of potential answers based on an evaluation of said multiplicity of potential answers in accordance with said criteria.

175. An answer extraction system according to claim 174 and wherein said evaluation comprises scoring said multiplicity of potential answers in accordance with said criteria.

176. An answer extraction system according to claim 175 and also comprising:
computerized potential answer combining functionality operative to form a potential answer document by combining said multiplicity of potential answers;
computerized theme extraction functionality for carrying out theme extraction on said sub group of said multiplicity of potential answers, said theme extraction utilizing statistical analysis of the frequency of occurrence of words in said potential answer document to identify at least one theme word in said sub group of said multiplicity of potential answers, which theme word may or may not be a question keyword; and
computerized potential answer discarding functionality operative to discard potential answers belonging to said sub group of said multiplicity of potential answers which do not include at least one of said at least one theme word.

177. An answer extraction system according to claim 176 and wherein said computerized theme extraction functionality comprises:
computerized word stemming functionality, operative, for each word in said potential answers document, to stem said word to a corresponding root word;
a word occurrence frequency score generator for generating a word occurrence frequency score for each different root word corresponding to a word in said potential answers document;
computerized document word occurrence frequency indicating score calculating functionality operative to use said word occurrence frequency scores to calculate a document word occurrence frequency indicating score for said potential answers document; and
computerized word selecting functionality operative to select a subset of words in said potential answers document including at least one word having a word occurrence frequency score which is greater than or equal to said document word occurrence frequency indicating score.

178. An answer extraction system according to claim 177 and wherein said computerized document word occurrence frequency indicating score calculating functionality is operative to calculate said document word occurrence frequency indicating score by calculating at least one of an average of said word occurrence frequency scores and a median of said word occurrence frequency scores.

179. An answer extraction system according to claim 176 and wherein said computerized theme extraction functionality is operative to select, as said at least one theme word, at least one word having a word occurrence frequency score which is greater than or equal to twice said document word occurrence frequency indicating score.

180. An answer extraction system according to of claim 176 and also comprising:
computerized subset word occurrence frequency indicating score calculating functionality, operative to calculate a subset word occurrence frequency indicating score; and
computerized theme word selection functionality operative to select, as said at least one theme word, at least one of said subset of words having a word occurrence frequency score which is greater than or equal to said subset word occurrence frequency indicating score.

181. An answer extraction system according to claim 180 and wherein said computerized subset word occurrence frequency indicating score calculating functionality is operative to calculate said subset word occurrence frequency indicating score by calculating at least one of an average of said word occurrence frequency scores of words in said subset of words and a median of said word occurrence frequency scores of words in said subset of words.

182. An answer extraction system according to claim 170 and wherein said computerized answer extraction functionality provides said at least one answer to said user in an order governed at least in part by at least one of:
a word count of each one of said at least one answer; and
a score, resulting from application to each one of said at least one answer of at least one of the following criteria:
proximity of question keywords in said at least one answer;
proximity of classification words and nouns in said at least one answer; and
word count of at least part of said at least one answer.

183. An answer extraction system according to claim 170 and wherein said computer is operative to receive said question from at least one of:
a keyboard;
a voice responsive input device;
a screen scraping functionality;
an email functionality;
an SMS functionality; and
an instant messaging functionality.

184. An answer extraction system according to claim 170 and also comprising:
computerized question normalizing functionality for normalizing said question; and
computerized question classification functionality for classifying said question.

185. An answer extraction system according to claim 184 and wherein said computerized question normalizing functionality is operative to normalize said question based at least in part on at least one of a plurality of question normalization rules.

186. An answer extraction system according to claim 170 and wherein said computerized answer extraction functionality is operative to employ said computer to derive said document search terms, including at least one additional search term not present in the question, which said at least one additional search term was acquired prior to receipt of said question from said user.

187. An answer extraction system according to claim 170 and wherein said computerized answer extraction functionality is operative to employ said computer to derive said document search terms, including at least one additional search term not present in the question by replacing at least one word in said question by at least one selected synonym thereof.

188. An answer extraction system according to claim 187 and wherein said computerized answer extraction functionality includes computerized synonym retrieving functionality operative to identify said at least one selected synonym at least partially by reference to at least one word in said question other than said at least one word which is replaced by said at least one selected synonym.

189. An answer extraction system according to claim 188 and wherein said computerized synonym retrieving functionality includes a corpus and said computerized synonym retrieving functionality is operative to search said corpus for occurrences of at least one of a plurality of synonyms for which there exists a phrase relevant to said question and to designate at least one of said plurality of synonyms as a selected synonym in accordance with a number of occurrences in said corpus of a phrase, including said at least one of said plurality of synonyms relevant to said question.

190. An answer extraction system according to claim 170 and wherein said computerized answer extraction functionality comprises computerized document analysis functionality operative to identify capitalized phrases which appear in at least one of said set of documents, to identify designated capitalized words belonging to said capitalized phrases and to add to said at least one of said set of documents, adjacent each occurrence of a designated capitalized word that does not appear in a capitalized phrase, the designated capitalized word that does appear alongside thereof elsewhere in said at least one of said set of documents in a capitalized phrase, thereby providing an enhanced document, and to carry out analysis of said enhanced document in order to identify at least one portion thereof as a potential answer.

191. An answer extraction system according to claim 190 and wherein said computerized answer extraction functionality also comprises an expected answer generator operative to generate an expected answer to said question, said expected answer including question keywords, and wherein said computerized document analysis functionality comprises:
computerized theme extraction functionality for carrying out theme extraction on said enhanced document, said theme extraction utilizing statistical analysis of the frequency of occurrence of words to identify at least one theme word of said enhanced document, which theme word may or may not be a question keyword;
a sentence extractor, operative to extract sentences from said enhanced document;
a potential answer selector, operative to select at least one of said sentences as a potential answer if it fulfills at least one of the following criteria:
a sentence including at least a predetermined plurality of question keywords; and
a sentence including at least one question keyword and at least one theme word; and
a potential answer identifier, operative to calculate a score for each of said at least one of said sentences selected as a potential answer and to identify at least one of said sentences selected as a potential answer based at least partially on results of said score.

192. An answer extraction system according to claim 170 and also comprising a document output device for providing a representation of at least one of said set of documents to said user.

193. An answer extraction system according to claim 192 and wherein said document output device comprises a display for presenting at least one link to said at least one of said set of documents.

194. An answer extraction system according to claim 170 and also comprising an answer output device for providing said at least one answer to said user.

195. An answer extraction system according to claim 194 and wherein said answer output device comprises a display for presenting said at least one answer in an editable report precursor format.

196. An answer extraction method according to claim 170 and wherein said question is not phrased in question format.

197. A document searching method comprising:
employing a computer to receive a query including at least one search term from a user; and
employing computerized synonym retrieving functionality operative in response to queries to generate document search terms including at least one additional search term not present in said query, said computerized synonym retrieving functionality being operative to generate said at least one additional search term by replacing at least one word in said query by at least one selected synonym thereof; and
operating computerized search engine functionality to access a set of documents in response to said query, based on at least one of said at least one search term supplied by a user and said at least one additional search term provided by said computerized synonym retrieving functionality,
said computerized synonym retrieving functionality being operative to identify said at least one selected synonym at least partially by reference to at least one word in said query other than said at least one word.

198. A document searching method according to claim 197 and wherein said computerized synonym retrieving functionality is operative to identify said at least one selected synonym by:
identifying a plurality of synonyms; and
selecting at least one of said plurality of synonyms for which there exists a phrase relevant to said query in a corpus.

199. A document searching method according to claim 198 and wherein said computerized synonym retrieving functionality is operative to identify said selected synonym by:
searching said corpus for occurrences of said at least one of said plurality of synonyms for which there exists a phrase relevant to said query; and
designating at least one of said plurality of synonyms as a selected synonym in accordance with the number of occurrences in said corpus of a phrase including said at least one of said plurality of synonyms which is relevant to said query.

200. A document searching method according to claim 197 and wherein said query is a question.

201. A document searching method according to claim 197 and wherein said query is not a question.

202. A document searching method according to claim 197 and wherein said at least one word in said query which is replaced by said at least one selected synonym thereof comprises at least one of a noun, a verb, an object of a verb and a subject of a verb.

203. A document searching system comprising:
a computer operative to receive a query including at least one search term from a user;
computerized synonym retrieving functionality operative, in response to queries, to generate document search terms, including at least one additional search term not present in said query and to generate said at least one additional search term by replacing at least one word in said query by at least one selected synonym thereof; and
computerized search engine functionality operative to access a set of documents in response to said query, based on at least one of said at least one search term supplied by a user and said at least one additional search term provided by said computerized synonym retrieving functionality,
said computerized synonym retrieving functionality being operative to identify said selected synonym at least partially by reference to a word in said query other than said at least one word.

204. A document searching system according to claim 203 and wherein said computerized synonym retrieving functionality comprises a synonym selector operative to identify a plurality of synonyms and to select at least one of said plurality of synonyms for which there exists a phrase relevant to said query in a corpus.

205. A document searching system according to claim 204 and wherein said synonym selector is operative to identify said selected synonym by:
searching said corpus for occurrences of said at least one of said plurality of synonyms for which there exists a phrase relevant to said query; and
designating at least one of said plurality of synonyms as a selected synonym in accordance with the number of occurrences in said corpus of a phrase including said at least one of said plurality of synonyms which is relevant to said query.

206. A document searching system according to claim 203 and wherein said query is a question.

207. A document searching system according to claim 203 and wherein said query is not a question.

208. A document searching system according to claim 203 and wherein said at least one word in said query which is replaced by said at least one selected synonym thereof comprises at least one of a noun, a verb, an object of a verb and a subject of a verb.

209. A computerized synonym generating method comprising:
receiving a stream of words;
employing a computer for generating a list of synonyms for at least one word in said stream of words;
employing a computer for searching a corpus for synonym-containing phrases including at least one synonym in said list of synonyms together with at least part of said stream of words;
employing a computer for evaluating the frequency of occurrence of each of said synonym-containing phrases; and
proposing at least one selected synonym which forms part of a synonym-containing phrase having a relatively high frequency of occurrence in said corpus.

210. A computerized synonym generating method according to claim 209 and also comprising:
employing a computer for searching said corpus for received phrases including said at least one word together with said at least part of said stream of words;
employing a computer for comparing the frequency of occurrence of said received phrases in said corpus with the frequency of occurrence of said synonym-containing phrases; and
proposing at least one selected synonym which forms part of a synonym-containing phrase only if the frequency of occurrence of said synonym-containing phrase exceeds the frequency of occurrence of said received phrase.

211. A computerized synonym generating method according to claim 209 and wherein said at least one word comprises at least one of a noun, a verb, an object of a verb and a subject of a verb.

212. A computerized synonym generating system comprising:
a computer operative to generate a list of synonyms for at least one word in a stream of words received from a user;
computerized searching functionality operative to search a corpus for synonym-containing phrases including at least one synonym in said list of synonyms together with at least part of said stream of words;
computerized frequency evaluation functionality operative to evaluate the frequency of occurrence of each of said synonym-containing phrases; and
computerized synonym providing functionality operative to propose at least one selected synonym which forms part of a synonym-containing phrase having a relatively high frequency of occurrence in said corpus.

213. A computerized synonym generating system according to claim 212 and also comprising:
computerized received phrases searching functionality operative to search said corpus for received phrases including said at least one word together with said at least part of said stream of words; and
computerized occurrence frequency comparing functionality operative to compare the frequency of occurrence of said received phrases in said corpus with the frequency of occurrence of said synonym-containing phrases,
said computerized synonym providing functionality being operative to propose at least one selected synonym which forms part of a synonym-containing phrase only if the frequency of occurrence of said synonym-containing phrase exceeds the frequency of occurrence of said received phrase.

214. A computerized synonym generating system according to of claim 212 and wherein said at least one word comprises at least one of a noun, a verb, an object of a verb and a subject of a verb.

215. A computerized question generation method comprising:
identifying at least one theme word in a document;
searching for previously asked questions containing said at least one theme word or having previously generated answers containing said at least one theme word; and
presenting said previously asked questions.

216. A computerized question generation method according to claim 215 and also comprising, prior to said identifying, employing a computer to obtain said document from a user, and wherein said presenting comprises presenting said previously asked questions on said computer to said user.

217. A computerized question generation method according to claim 215 and wherein said identifying comprises carrying out statistical analysis of the frequency of occurrence of words in said document.

218. A computerized question generation method according to claim 217 and wherein said carrying out statistical analysis comprises:
for each word in said document, stemming said word to a corresponding root word;
generating a word occurrence frequency score for each different root word corresponding to a word in said document;
using said word occurrence frequency scores to calculate a document word occurrence frequency indicating score for said document; and
selecting a subset of words in said document including at least one word having a word occurrence frequency score which is greater than or equal to at least said document word occurrence frequency indicating score.

219. A computerized question generation method according to claim 218 and wherein said document word occurrence frequency indicating score comprises at least one of an average of said word occurrence frequency scores and a median of said word occurrence frequency scores.

220. A computerized question generation method according to claim 215 and wherein said identifying at least one theme word comprises selecting, as said at least one theme word, at least one word having a word occurrence frequency score which is greater than or equal to twice said document word occurrence frequency indicating score.

221. A computerized question generation method according to claim 215 and wherein said carrying out statistical analysis also comprises, following said selecting a subset of words in said document:
calculating a subset word occurrence frequency indicating score; and
selecting, as said at least one theme word, at least one of said subset of words having a word occurrence frequency score which is greater than or equal to said subset word occurrence frequency indicating score.

222. A computerized question generation method according to claim 221 and wherein said subset word occurrence frequency indicating score comprises at least one of an average of said word occurrence frequency scores of words in said subset of words and a median of said word occurrence frequency scores of words in said subset of words.

223. A computerized question generation system comprising:
computerized theme word identifying functionality for identifying at least one theme word in a document;
computerized previous answer searching functionality operative to search for previously asked questions containing said at least one theme word or having previously generated answers containing said at least one theme word; and
an output device for providing said previously asked questions.

224. A computerized question generation system according to claim 223 and wherein said computerized theme word identifying functionality is operative to carry out statistical analysis of the frequency of occurrence of words in said document.

225. A computerized question generation system according to claim 224 and wherein said computerized theme word identifying functionality comprises:
computerized word stemming functionality, operative, for each word in said document, to stem said word to a corresponding root word;
a word occurrence frequency score generator for generating a word occurrence frequency score for each different root word corresponding to a word in said document;
computerized document word occurrence frequency indicating score calculating functionality operative to use said word occurrence frequency scores to calculate a document word occurrence frequency indicating score for said document; and
computerized word selecting functionality operative to select a subset of words in said document including at least one word having a word occurrence frequency score which is greater than or equal to said document word occurrence frequency indicating score.

226. A computerized question generation system according to claim 225 and wherein said computerized document word occurrence frequency indicating score calculating functionality is operative to calculate said document word occurrence frequency indicating score by calculating at least one of an average of said word occurrence frequency scores and a median of said word occurrence frequency scores.

227. A computerized question generation system according to claim 225 and wherein said computerized theme word identifying functionality is operative to select, as said at least one theme word, at least one word having a word occurrence frequency score which is greater than or equal to twice said document word occurrence frequency indicating score.

228. A computerized question generation system according to claim 225 and wherein said computerized theme word identifying functionality also comprises:
computerized subset word occurrence frequency indicating score calculating functionality, operative to calculate a subset word occurrence frequency indicating score; and
computerized theme word selection functionality operative to select, as said at least one theme word, at least one of said subset of words having a word occurrence frequency score which is greater than or equal to said subset word occurrence frequency indicating score.

229. A computerized question generation system according to claim 228 and wherein said computerized subset word occurrence frequency indicating score calculating functionality is operative to calculate said subset word occurrence frequency indicating score by calculating at least one of an average of said word occurrence frequency scores of words in said subset of words and a median of said word occurrence frequency scores of words in said subset of words.

230. A computerized editable report precursor generating method comprising:
inputting at least one question into a computer;
employing said computer to obtain at least one answer to said at least one question;
storing said at least one answer to said at least one question;
presenting said at least one question to said at least one answer in an editable form on said computer as an editable report precursor;
archiving a multiplicity of said editable report precursors; and
following said archiving, employing said multiplicity of editable report precursors to enhance said employing said computer.

231. A computerized editable report precursor generating method according to claim 230 and wherein said archiving includes archiving edited versions of said multiplicity of editable report precursors and wherein said edited versions are also employed to enhance said employing said computer.

232. A computerized editable report precursor generating method according to claim 230 and wherein said inputting comprises inputting said at least one question to said computer by at least one of:
typing said question;
using a voice responsive input device;
using a screen scraping functionality;
using an email functionality;
using an SMS functionality; and
using an instant messaging functionality.

233. A computerized editable report precursor generating method according to claim 230 and wherein said employing said computer comprises:
employing computerized answer retrieving functionality to generate document search terms including at least one additional search term not present in said question, which said additional search term was acquired, prior to receipt by said computer of said question from said user, by said computerized answer retrieving functionality in response to said at least one question; and
operating computerized search engine functionality to access a set of documents in response to said question, based not only on at least one search term supplied by a user but also on said at least one additional search term provided by said at least one computerized answer retrieving functionality.

234. A computerized editable report precursor generating method comprising:
inputting at least one desired report subject identifier into a computer;
employing said computer to generate at least one question related to a desired subject identified by said at least one desired report subject identifier;
employing said computer to obtain at least one answer to said at least one question; and
presenting said at least one question to said at least one answer in an editable form on said computer, thereby providing an editable report precursor.

235. A computerized editable report precursor generating method according to claim 234 and also comprising:
archiving a multiplicity of said editable report precursors; and
following said archiving, employing said multiplicity of editable report precursors to enhance at least one of said employing said computer to generate at least one question and said employing said computer to obtain at least one answer to said at least one question.

236. A computerized editable report precursor generating method according to claim 234 and wherein said archiving includes archiving edited versions of said multiplicity of editable report precursors and wherein said edited versions are also employed to enhance at least one of said employing said computer to generate at least one question and said employing said computer to obtain at least one answer to said at least one question.

237. A computerized editable report precursor generating method according to claim 234 and wherein said inputting comprises inputting said at least desired report subject identifier to said computer by at least one of:
typing said desired report subject identifier;
using a voice responsive input device;
using a screen scraping functionality;
using an email functionality;
using an SMS functionality; and
using an instant messaging functionality.

238. A computerized editable report precursor generating method according to claim 234 and wherein said employing said computer to generate said at least one question comprises employing said desirable report subject identifier to search for previously asked questions containing at least part of said desirable report subject identifier or having previously generated answers containing at least part of said desirable report subject identifier.

239. A computerized editable report precursor generating method according to claim 234 and wherein said employing said computer comprises:
employing computerized answer retrieving functionality to generate document search terms including at least one additional search term not present in said question, which said additional search term was acquired, prior to receipt by said computer of said desired report subject identifier from said user, by said computerized answer retrieving functionality in response to at least one query;
operating computerized search engine functionality to access a set of documents in response to said question, based not only on said desired report subject identifier but also on said at least one additional search term provided by said at least one computerized answer retrieving functionality.
